(19) United States
(12) Patent Application Publication
(10) Pub. No.: US 2008/0216256 A1
(43) Pub. Date: Sep. 11, 2008

(54) Heterobifunctional reactive dyes comprising a cysteamine linking group

(75) Inventors: Harold S. Freeman, Raleigh, NC (US); C. Brent Smith, Raleigh, NC (US); Malgorzata Szymczyk, Raleigh, NC (US); Mengnan Zhao, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: North Carolina State University, Raleigh, NC (US)

(21) Appl. No.: 11/894,599

(22) Filed: Aug. 21, 2007

Related U.S. Application Data
(60) Provisional application No. 60/838,969, filed on Aug. 21, 2006.

(51) Int. Cl. C09B 62/02; C09B 29/00

(52) U.S. Cl. 8/549; 534/802

(57) ABSTRACT

The presently disclosed subject matter relates to heterobifunctional reactive dyes comprising nitrogen-containing heterocycles substituted by both halogen and vinyl sulfone moieties. In particular, the presently disclosed subject matter relates to reactive dye compounds comprising two or more halo-substituted, nitrogen-containing heterocycles and an asymmetric bridging group, wherein at least one of the two or more halo-substituted, nitrogen-containing heterocycles further comprises a vinyl sulfone substituent. In some embodiments, the bridging group has a structure based on cysteamine or cysteine. The heterobifunctional reactive dyes have high substrate affinity and can be applied to substrates, such as cotton fibers, under low salt conditions and with reduced dye material waste.

### RELATED APPLICATIONS

The presently disclosed subject matter claims the benefit of U.S. Provisional Patent Application Ser. No. 60/838,969, filed Aug. 21, 2006; the disclosure of which is incorporated herein by reference in its entirety.

### TECHNICAL FIELD

The presently disclosed subject matter relates to reactive dye compounds and compositions. In particular, the presently disclosed subject matter relates to reactive dye compounds comprising heterobifunctional groups. The reactive dye compounds can comprise two or more halo-substituted, nitrogen-containing heterocycles and an asymmetric bridging group, wherein at least one of the two or more halo-substituted, nitrogen-containing heterocycles comprises a vinyl sulfone group.

### ABBREVIATIONS

λₘₐₓ=absorption maximum
° C.=degrees Celsius
εₘₐₓ=molecular absorptivity
cm=centimeter
CR=commercial red dye
CY=commercial yellow dye
DCQ=dichloroquinoxaline
DCT=dichlorotriazine
DFCP=difluorochloropyrimidine
DMF=N,N-dimethylformamide
eq.=equivalent
g=gram
IR=infrared
L=liter
MCT=monochlorotriazine
MCT-VS=monochlorotriazine-vinyl sulfone
MFT=monofluorotriazine
min=minute
mL=milliliter
mol=mole
nm=nanometer
TCP=trichloropyrimidine
UV=ultraviolet
VS=vinyl sulfone
w/v=weight/volume

### BACKGROUND

Reactive dye compounds are known in the art for dyeing a variety of substrates. Such substrates include, for example, proteinaceous materials, such as keratin (e.g., found in hair, skin, nails, and various animal body parts such as horns, hooves and feathers) and other naturally occurring protein containing materials, such as silk. Other dyeable substrates include saccharide-derived materials, such as cellulose or cellulose derivatives (e.g., cotton), and synthetic fibers such as polyamides.

Reactive dyes react with substrates to form covalent bonds and, thus, can impart bright shades having stability to color loss after repeated washing. Typical reactive dyes, however, have low affinity for cotton, requiring the use of high salt levels (e.g., 100 g/L or greater) to promote exhaustion from dye baths. Additionally, many reactive dyes are subject to hydrolysis during the dyeing process, producing structures that cannot react with the substrate. In some cases, as much as 50% of the parent reactive dye hydrolyzes to a non-reactive structure.

Thus, one critical problem still facing the textile dye industry is the large amount of dye and salt needed to produce desired shade depth levels in dyed substrates. Another problem is the significant level of dye-based color and salt which remain in the waste water after the dyeing process is finished. New types of reactive dyes are needed that have higher affinity for substrates, particularly under low salt conditions. Also needed are reactive dyes that give high fiber-fixation levels during the dyeing process, producing less wasted dye.

### SUMMARY

In some embodiments, the presently disclosed subject matter provides a reactive dye compound comprising two or more halo-substituted, nitrogen-containing heterocycles and an asymmetric bridging group, wherein at least one of the two or more halo-substituted, nitrogen-containing heterocycles further comprises a vinyl sulfone substituent. In some embodiments, two of the two or more halo-substituted, nitrogen-containing heterocycles further comprise a vinyl sulfone substituent. In some embodiments, the asymmetric bridging group has a structure based on cysteamine or cysteine.

In some embodiments, the reactive dye compound has a structure of Formula (I):

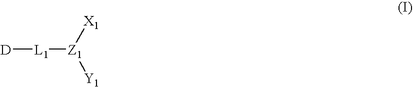

wherein:

D is a chromophore;

L₁ is selected from the group consisting of NR₁, NR₁C(═O), and NR₁, (SO₂), wherein R₁ is H or alkyl;

Z₁ is a nitrogen-containing heterocycle;

X₁ has a structure of Formula (II):

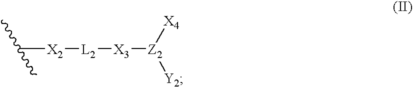

wherein:
X₂ is S, O, or NR₂, wherein R₂ is H or alkyl;
L₂ can be present or absent, and if present is selected from the group consisting of C₁-C₅ alkylene, C₁-C₅ substituted alkylene, and arylene;
X₃ can be present or absent, and if present is S, O, or NR₃, wherein R₃ is H or alkyl;
Z₂ is a nitrogen-containing heterocycle;
Y₂ is halo; and
X₄ is -L₃-Z₃-SO₂CH₂CH₂OSO₃H, wherein Z₃ is arylene and L₃ is NR₄, O, or S, wherein R₄ is H or alkyl; and

Y₁ is halo or a group having a structure of Formula (III):

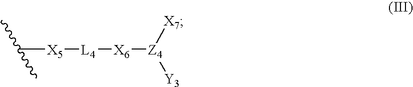

wherein:
X₅ is S, O, or NR₅, wherein R₅ is H or alkyl;
L₄ can be present or absent, and if present is selected from the group consisting of C₁-C₅ alkylene, C₁-C₅ substituted alkylene, and arylene;
X₆ can be present or absent, and if present is S, O, or NR₆, wherein R₆ is H or alkyl;
Z₄ is a nitrogen-containing heterocycle;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

In some embodiments, Z₁ and Z₂ are independently selected from the group consisting of triazine, pyrimidine, quinoxaline, phthalazine, pyridazone, and pyrazine.

In some embodiments, X₂ is S; L₂ is ethylene or carboxyl-substituted ethylene; and X₃ is NR₃, wherein R₃ is H; and X₁ has a structure of Formula (IIa):

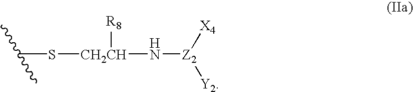

In some embodiments, R₈ is H; Z₂ is triazine; Z₃ is phenylene; L₃ is NR₄, wherein R₄ is H; and X₁ has a structure of Formula (IIb):

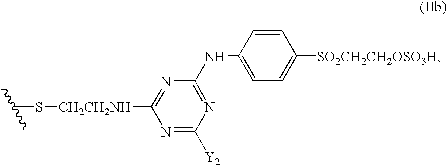

wherein Y₂ is chloro or fluoro.

In some embodiments, Z₁ is triazine; L₁ is NR₁, wherein R₁ is H; and the reactive dye compound has a structure of Formula (Ia):

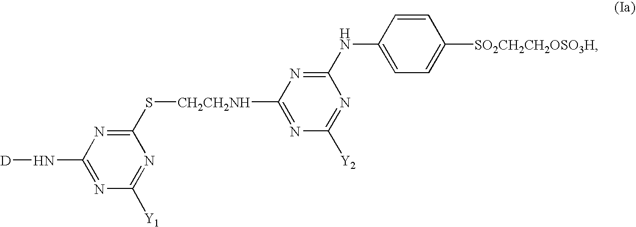

wherein D is a chromophore; Y₂ is chloro or fluoro; and Y₁ is chloro or fluoro. In some embodiments, Y₁ and Y₂ are Cl.

In some embodiments, the reactive dye compound is selected from:

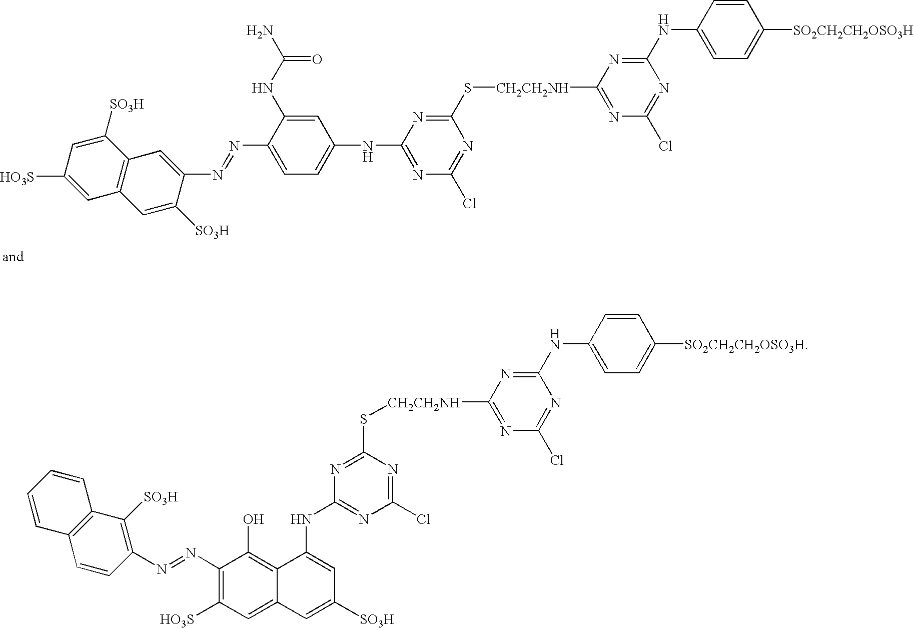

In some embodiments, X₅ is S; L₄ is ethylene or carboxyl-substituted ethylene; X₆ is NR₆, wherein R₆ is H; and Y₁ has a structure of Formula (IIIa):

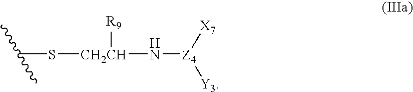

In some embodiments, R₉ is H; Z₄ is triazine; Z₅ is phenylene; L₅ is NR₇, wherein R₇ is H; and Y₁ is a structure of Formula (IIIb):

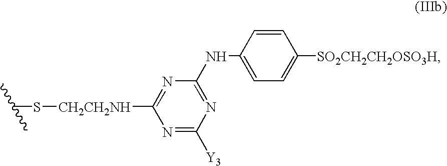

wherein Y₃ is chloro or fluoro.

In some embodiments, Z₁ is triazine; and L₁ is NR₁, wherein R₁ is H; and the reactive dye compound has a structure of Formula (Ib):

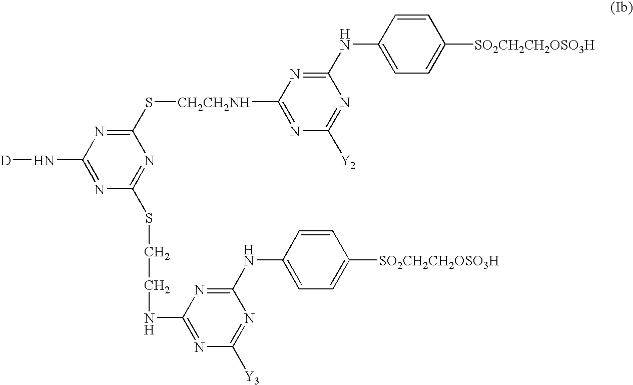

wherein D is a chromophore; and Y₂ and Y₃ are independently chloro or fluoro. In some embodiments, Y₂ and Y₃ are each Cl.

In some embodiments, the reactive dye compound is selected from the group consisting of:

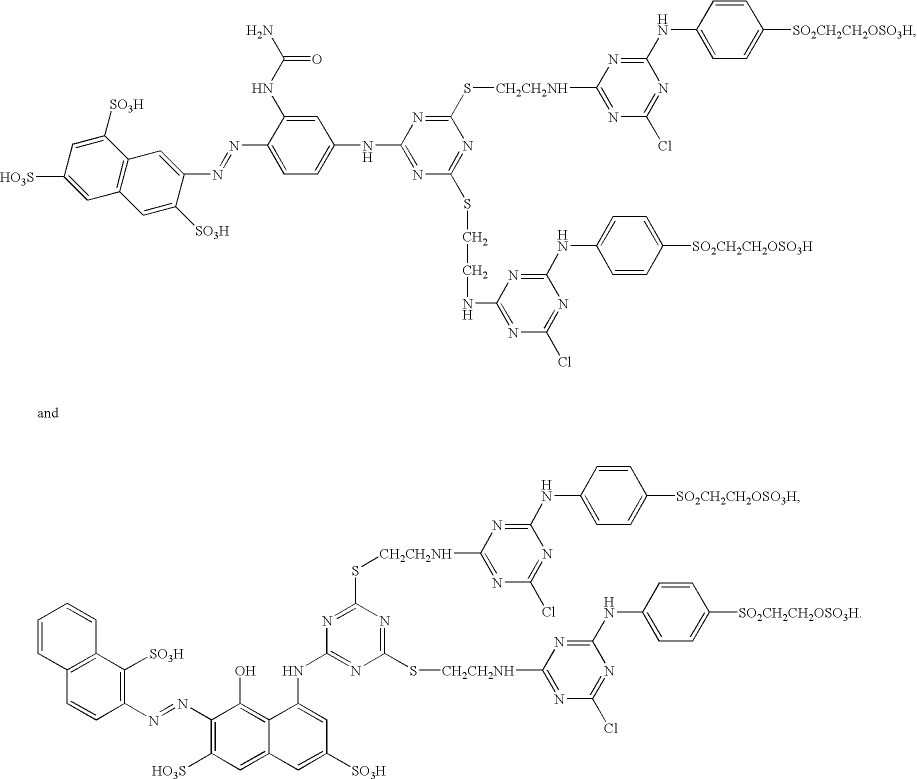

In some embodiments, the presently disclosed subject matter provides a dye bath composition comprising a reactive dye compound, the reactive dye compound comprising two or more halo-substituted, nitrogen-containing heterocycles and an asymmetric bridging group, wherein at least one of the two or more halo-substituted, nitrogen-containing heterocycles further comprises a vinyl sulfone substituent. In some embodiments, the dye bath composition further comprises a salt, and the dye bath composition has a salt concentration of about 70 g/L or less.

In some embodiments, the presently disclosed subject matter provides a method of dyeing a cellulosic fiber comprising contacting the cellulosic fiber with a dye bath composition comprising a reactive dye compound, said reactive dye compound comprising two or more halo-substituted, nitrogen-containing heterocycles and an asymmetric bridging group, wherein at least one of the two or more halo-substituted, nitrogen-containing heterocycles further comprises a vinyl sulfone substituent. In some embodiments, the cellulosic fiber is cotton. In some embodiments, the dye bath composition has a salt level of 70 g/L or less. In some embodiments, contacting the cellulosic fiber with the dye bath composition is performed at a temperature of up to about 90° C. In some embodiments, the temperature is between about 30° C. and about 60° C.

It is an object of the presently disclosed subject matter to provide highly efficient reactive dyes and dye compositions.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

FIG. 1A is a bar graph showing the shade depth values (K/S) of cotton fabric dyed with commercial yellow dye (CY), heterobifunctional yellow dye 1 (Y1), or heterobifunctional yellow dye 3 (Y3) at temperatures of 30° C. and 60° C. and at salt levels of 40 g/L and 70 g/L.

FIG. 1B is a bar graph showing the shade depth values (K/S) of cotton fabric dyed with commercial red dye (CR), heterobifunctional red dye 1 (R1), or heterobifunctional red dye 3 (R3) at temperatures of 30° C. and 60° C. and at salt levels of 40 g/L and 70 g/L.

### DETAILED DESCRIPTION

The presently disclosed subject matter will now be described more fully hereinafter with reference to the accompanying Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist.

### I. Definitions

Following long-standing patent law convention, the terms “a”, “an”, and “the” refer to “one or more” when used in this application, including the claims. Thus, for example, reference to “a reactive dye compound” includes mixtures of one or more reactive dye compounds, two or more reactive dye compounds, and the like.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the presently disclosed subject matter.

The term “about”, as used herein when referring to a measurable value such as an amount of weight, time, temperature, concentration, etc. is meant to encompass in one example variations of ±20% or ±10%, in another example 5%, in another example ±1%, and in yet another example ±0.1% from the specified amount, as such variations are appropriate to perform the disclosed methods.

As used herein the term “alkyl” refers to C₁₋₂₀ inclusive, linear (i.e., “straight-chain”), branched, or cyclic (a “cycloalkyl”), saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, methylpropynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Further, as used herein, the terms alkyl and/or “substituted alkyl” include an “allyl” or an “allylic group.” The terms “allylic group” or “allyl” refer to the group —CH₂HC═CH₂ and derivatives thereof formed by substitution. Thus, the terms alkyl and/or substituted alkyl include allyl groups, such as but not limited to, allyl, methylallyl, di-methylallyl, and the like. The term “allylic position” or “allylic site” refers to the saturated carbon atom of an allylic group. Thus, a group, such as a hydroxyl group or other substituent group, attached at an allylic site can be referred to as “allylic.”

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include, but are not limited to, cyclopropyl, cyclobutyl, cyclopentyl, cyclohexyl, cycloheptyl, and the like. Further, the cycloalkyl group can be optionally substituted with a linking group, such as an alkylene group as defined hereinabove, for example, methylene, ethylene, propylene, and the like. In such cases, the cycloalkyl group can be referred to as, for example, cyclopropylmethyl, cyclobutylmethyl, and the like. Additionally, multicyclic cycloalkyl rings include adamantyl, octahydronaphthyl, decalin, camphor, camphane, and noradamantyl.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds. The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, e.g., 5, 6, 7, 8, 9, or 10 carbon atoms, and including 5 and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, fluorene, and the like.

“Aralkyl” refers to an aryl-alkyl-group wherein aryl and alkyl are as previously described, and included substituted aryl and substituted alkyl. Exemplary aralkyl groups include benzyl, phenylethyl, and naphthylmethyl.

“Alkylene” refers to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 1 to about 3 carbon atoms and can further have 6-20 carbons.

“Arylene” refers to a bivalent aryl group. An exemplary arylene is phenylene, which can have ring carbon atoms available for bonding in ortho, meta, or para positions with regard to each other, i.e.,

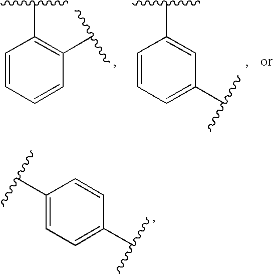

respectively. The arylene group can also be naphthylene or a divalent fluorene moiety. The arylene group can be optionally substituted (a “substituted arylene”) with one or more “aryl group substituents” as defined herein, which can be the same or different.

“Aralkylene” refers to a bivalent group that contains both alkyl and aryl groups. For example, aralkylene groups can have two alkyl groups and an aryl group (i.e., -alkyl-aryl-alkyl-), one alkyl group and one aryl group (i.e., -alkyl-aryl-) or two aryl groups and one alkyl group (i.e., -aryl-alkyl-aryl-)

As used herein, the term “acyl” refers to an organic carboxylic acid group (i.e., RC(═O)OH) wherein the —OH has been replaced with another substituent. Thus, an acyl group can be represented by RC(═O)—, wherein R is an alkyl, aralkyl, or aryl group as defined herein. As such, the term “acyl” specifically includes arylacyl groups, such as an acetylfuran and a phenacyl group. Specific examples of acyl groups include acetyl and benzoyl.

“Alkoxyl” refers to an alkyl-O— group wherein alkyl is as previously described. The term “alkoxyl” as used herein can refer to, for example, methoxyl, ethoxyl, propoxyl, isopropoxyl, butoxyl, t-butoxyl, and pentoxyl. The terms “oxyalkyl” and “alkoxy” can be used interchangably with “alkoxyl”.

“Aryloxyl” and “aryloxy” refer to an aryl-O— group wherein the aryl group is as previously described, including a substituted aryl. The term “aryloxyl” as used herein can refer to phenyloxyl or hexyloxyl, and alkyl, substituted alkyl, halo, or alkoxyl substituted phenyloxyl or hexyloxyl.

“Aralkyloxyl” and “aralkyloxy” refer to an aralkyl-O— group wherein the aralkyl group is as previously described. An exemplary aralkyloxyl group is benzyloxyl.

“Alkoxycarbonyl” refers to an alkyl-O—C(═O)— group. Exemplary alkoxycarbonyl groups include methoxycarbonyl, ethoxycarbonyl, butyloxycarbonyl, and t-butyloxycarbonyl.

“Aryloxycarbonyl” refers to an aryl-O—C(═O)— group. Exemplary aryloxycarbonyl groups include phenoxy- and naphthoxy-carbonyl.

“Aralkoxycarbonyl” refers to an aralkyl-O—C(═O)— group. An exemplary aralkoxycarbonyl group is benzyloxycarbonyl.

“Carbamoyl” refers to an H₂N—C(═O)— group.

“Alkylcarbamoyl” refers to a R′RN—C(═O)— group wherein one of R and R′ is hydrogen and the other of R and R′ is alkyl and/or substituted alkyl as previously described.

“Dialkylcarbamoyl” refers to a R′RN—C(═O)— group wherein each of R and R′ is independently alkyl and/or substituted alkyl as previously described.

“Acyloxyl” and “acyloxy” refer to an acyl-O— group wherein acyl is as previously described.

“Acylamino” refers to an acyl-NH— group wherein acyl is as previously described.

The term “carbonyl” refers to the —C(═O)— group.

The term “carboxyl” refers to the —COOH group.

The terms “halo”, “halide”, or “halogen” as used herein refer to fluoro (—F), chloro (—Cl), bromo (—Br), and iodo (—I) groups. In some embodiments, the term halo refers to —F or —Cl.

The terms “hydroxyl” and “hydroxyl” refer to the —OH group.

The term “hydroxyalkyl” refers to an alkyl group substituted with an —OH group.

The term “mercapto” refers to the —SH group.

The term “oxo” refers to a compound described previously herein wherein a carbon atom is replaced by an oxygen atom.

The term “nitro” refers to the —NO₂ group.

The term “cyano” refers to a —CN group, wherein the carbon and nitrogen atoms are bonded by a triple bond.

The terms “thio” and “sulfo” refer to a compound described previously herein wherein a carbon or oxygen atom is replaced by a sulfur atom.

The terms “sulfate” and sulfato” refer to the —SO₄ or —OSO₃— group.

The term “sulfone” refers to the —SO₂— group.

The term “sulfamoyl” refers to the —SO₂—NH₂ group.

The term “amino” refers to primary amines (i.e., the —NH₂ group) as well as to secondary and tertiary amines. The term “alkylamino” refers to an amino group wherein one of the hydrogen atoms is replaced by an alkyl group. The term “dialkylamino” refers to an amino group wherein both hydrogen atoms are replaced by alkyl groups. The alkyl groups of the dialkylamino group can be the same or different.

The term “nitrogen-containing heterocycle” as used herein refers to a monocyclic, bicyclic, or polycyclic, unsaturated heterocycle containing at least one nitrogen heteroatom. The nitrogen-containing heterocycle can be substituted or unsubstituted. The ring atoms of the nitrogen-containing heterocycle can be substituted by any of the alkyl or aryl group substituents described herein.

Monocyclic nitrogen-containing heterocycles can be selected from unsaturated rings having from about 3 to about 7 ring atoms, wherein 1, 2, or 3 of the ring atoms are nitrogen atoms. In some embodiments, the monocyclic nitrogen-containing heterocycle will comprise 5 or 6 ring atoms. Bicyclic nitrogen-containing heterocycles can comprise an unsaturated nitrogen-containing heterocycle having 3 to 7 ring atoms fused to a 5- to 7-membered carbocycle. In some embodiments, the bicyclic heterocycle comprises a 6-membered unsaturated carbocycle (i.e., a 6-membered aryl ring) fused to a 3-7 atom nitrogen-containing ring.

Exemplary nitrogen-containing heterocycles include, but are not limited to, triazine, pyrimidine, quinoxaline, pyrimidinone, phthalazine, pyridazone, and pyrazine.

The term “vinyl sulfone” refers to vinyl and β-substituted sulfones (i.e., —SO₂—CH═CH₂ and —SO₂—CH₂—CH₂—R groups). R can be any alkyl group substituent. In some embodiments, R is —OSO₃H, and the vinyl sulfone group is a β-sulfatoethyl sulfone.

The term heteroatom refers to an atom other than carbon or hydrogen. In some embodiments, the term heteroatom refers to N, O, and S.

The term “bridging moiety” or “bridging group” refers to a linker group (i.e., a bivalent chemical structure) that attaches one nitrogen-containing heterocycle to another nitrogen-containing heterocycle within the same reactive dye compound.

When the term “independently selected” is used, the substituents being referred to (e.g., R, L, X, or Y groups, such as groups X₁ and X₂) can be identical or different. For example, X₁ can be S and X₂ can be 0, or both X₁ and X₂ can be S.

Wavy lines can be used in the chemical formulas described herein to indicate the attachment site of the specified structure or group to another chemical moiety, for example, to a chromophore-containing structure. For example, the structure:

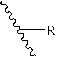

indicates that the group R is attached to another chemical moiety.

Some groups can be described as being present or absent. Thus, in some embodiments, the group is present. In some embodiments, the group is absent and is replaced by a direct bond.

As used herein, the term “exhaustion” in relation to reactive dyes means the percentage of dye which is transferred from a solution of the dye (e.g., a dye bath) to the substrate to be treated at the end of the dyeing process (e.g., before any rinsing or soaping off steps). Thus, 100% exhaustion (% E) means that 100% of the dye is transferred from the dye solution to the substrate.

### II. Reactive Dyes

II.A. Reactive Groups

The term “reactive dye” refers to any dye comprising one or more reactive groups capable of forming a covalent bond with the substrate to be dyed, or to any dye that forms such a reactive group in situ. The reactive group can be attached directly to a chromophore or can be attached to a chromophore via one or more linker group.

In many embodiments, the reactive group can comprise a leaving group. The function of the leaving groups is to be substituted during the dyeing process by a nucleophilic group on the surface of the substrate. The covalent bond formed after the substitution accounts for the stability of the color on the substrate after the dyeing process is completed. In the case of cellulosic fibers, which comprise hydroxyl-containing polysaccharides, the substitution process is usually carried out under alkaline conditions (pH>8) in order to generate a sufficient concentration of nucleophilic oxyanions on the substrate surface. See Scheme 1, below, which illustrates the partial deprotonation of cellulose under alkaline conditions.

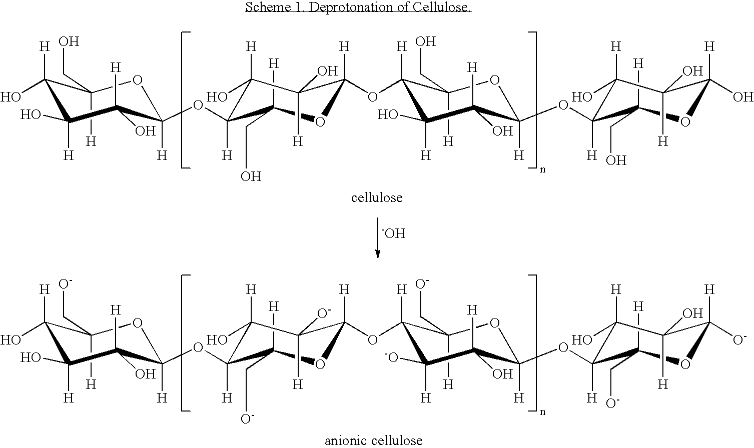

In some embodiments, it can be beneficial to include more than one reactive group on the reactive dye to increase the reactivity of the dye to the substrate. For example, reactive dyes comprising more than one reactive group can form covalent bonds to more than one nucleophilic group on one substrate fiber or can form covalent bonds with nucleophilic groups on multiple fibers within the substrate, thereby providing a cross-linkage between substrate fibers.

In reactive dyes comprising more than one reactive group (i.e., two, three, four, or more reactive groups), the reactive groups can be the same or different. For example, a reactive dye or a particular substituent grouping within the reactive dye can comprise two of the same reactive groups. Such a dye or dye substituent can be referred to as “homobifuntional.” A reactive dye or reactive dye substituent can comprise two different reactive groups. Such a dye or dye substituent can be referred to as “heterobifunctional.”

Examples of leaving groups that are capable of being substituted during dyeing processes include, but are not limited to, —Cl, —Br, —F, —I, —SO₃H, —OSO₃H, —SSO₃H, —O—C₆H₄—SO₃H, —OC(═O)CH₃, —OPO₃H₂, —OC(═O)C₆H₅, —OSO₂—C₁-C₄-alkyl, —OSO₂—N(C₁-C₄ alkyl)₂, —O—C₆H₄—CO₂H, quaternized nitrogen derivatives, and the like. In particular, halogen atoms substituted on aryl groups can be useful leaving groups in reactive dye compounds. Dyes comprising aryl halogens (e.g., dichlorotriazine (DCT), monochlorotriazine (MCT), trichloropyrimidine (TCP), dichloroquinoxaline (DCQ), difluorochloropyrimidine (DFCP), and monofluorotriazine (FT) reactive dyes) can react with nucleophiles, such as anionic cellulose as shown in Scheme 2, below. Under alkaline conditions for the deprotonation of cellulose, a competing hydrolysis reaction can occur with the dye, in which hydroxide can react with the aryl halogen to form a hydrolyzed dye product (i.e., a phenol).

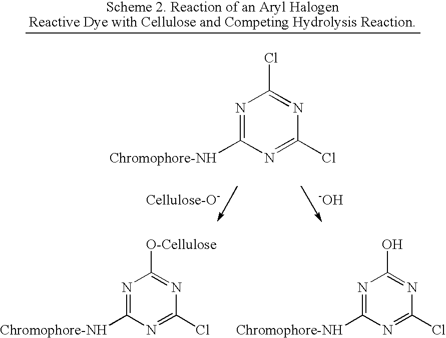

Reactive groups can also include electrophilic vinyl sulfone (VS) groups. Vinyl sulfones include both unmasked vinyl sulfones (e.g., —SO₂CH═CH₂) and masked vinyl sulfones, such as β-substituted sulfones (e.g., —SO₂—CH₂CH₂—R groups). R can be a leaving group, such as halo, aryloxy, or acyloxy, as described herein. In some embodiments, R is —OSO₃H and the vinyl sulfone group is α-sulfonatoethyl sulfone. Under proper conditions, the bond to the leaving group of the masked vinyl sulfone group will be broken, leaving behind the electrophilic double bond of the unmasked vinyl sulfone, which, in turn, can react with a nucleophilic group on the substrate. A vinyl sulfone group can react with anionic cellulose under alkaline conditions as shown in Scheme 3, below.

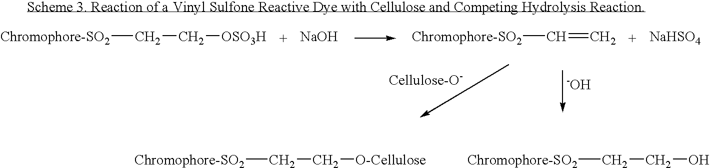

The presently disclosed subject matter relates to reactive dye compounds comprising two or more halo-substituted, nitrogen-containing heterocycles and an asymmetric bridging group, wherein at least one of the two or more halo-substituted, nitrogen-containing heterocycles is heterobifunctional, comprising a second reactive group in addition to the aryl halogen substituent. In some embodiments, the second reactive group is a vinyl sulfone.

In some embodiments, the reactive dye compound comprises at least one bridging moiety based on the structure of cysteine or cysteamine. Thus in some embodiments, the reactive dye compound comprises at least one bridging group having a structure selected from:

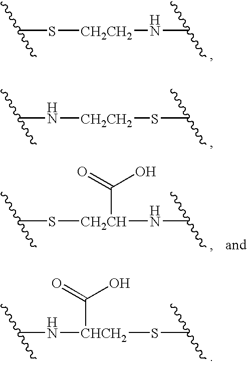

In some embodiments, the halo-substituted, nitrogen-containing heterocycles are chloro and/or fluoro-substituted nitrogen-containing heterocycles. In some embodiments, the halo-substituted, nitrogen-containing heterocycles are chlorotriazines. Thus, in some embodiments, the reactive dye compound can comprise at least one monochlorotriazine-vinyl sulfone (MCT-VS) group.

In some embodiments, at least two of the two or more halo-substituted, nitrogen-containing heterocycles comprise a vinyl sulfone. Thus, in some embodiments, the presently disclosed reactive dye comprises two heterobifunctional reactive groups. In some embodiments, the two heterobifunctional reactive groups are MCT-VS groups.

II.B. Chromophores

The reactive dyes described herein can comprise one or more chromophore moieties, D. Any chromophore moiety suitable for use in dyeing substrates can be used. In reactive dye compounds comprising more than one chromophore moiety, the chromophores can be the same or different.

The term “chromophore” as used herein refers to any photoactive compound, including colored and non-colored light absorbing species, such as, for example, fluorescent brighteners, UV absorbers, and IR absorbing dyes. Suitable chromophore moieties include radicals of monoazo, di-azo or polyazo dyes or of transition metal complex azo dyes derived therefrom. Such chromophore moieties include, but are not limited to, anthraquinone, phthalocyanine, formazan, azomethine, dioxazine, phenazine, stilbene, triphenylmethane, xanthene, thioxanthene, nitroaryl, naphthoquinone, pyrenequinone, or perylene-tetracarbimide dyes or combinations thereof. As will be understood by one of skill in the art, the color provided by the reactive dye can be controlled based on the identity of the chromophore. Chromophores can further include one or more substituents to enhance water solubility, such as, for example, sulfonate or amino substituents.

The chromophores of the presently disclosed reactive dyes can be based on those present in commercially available reactive dyes, including, but not limited to, dichlorotriazine (DCT) dyes, monochlorotriazine (MCT) dyes (available from Ciba-Geigy Corp. under the brand names CIBACRONE and CIBACRON™), vinyl sulfone (VS) dyes (available from Hoechst Celanese Corp. under the brand name REMAZOL™ and from Sumitomo Corp. of America under the brand name SUMIFIX™), trichloropyrimidine (TCP) dyes (available from Sandoz Corp. under the brand name DRIMAREN™ Z and from Ciba-Geigy Corp. under the brand name CIBACRON™ T-E.), dichloroquinoxaline (DCQ) dyes (available from Bayer Corp. under the brand name LEVAFIX™ E.), difluorochloropyrimidine (DFCP) dyes (available from Bayer Corp. under the brand names LEVAFIX™ E-A), monofluorotriazine (FT) dyes (available from Ciba-Geigy Corp. under the brand name CIBACRON™ F and from Bayer Corp. under the brand name LEVAFIX™ E-N.), and fluorochloromethylpyrimidine dyes (available from Bayer Corp. under the brand name LEVAFIX™ PN). Other suitable chromophore moieties for use in the presently disclosed reactive dye compounds include those disclosed in EP-A-0,735,107, incorporated herein by reference in its entirety, including the radicals described therein which contain substitutents customary for organic dyes.

In some embodiments, the chromophore moiety of the presently disclosed reactive dyes includes one of the polysulfonated azo chromophores present in a commercially available DCT reactive dye, such as one of the PROCION™ (DyStar Textilfarben GmbH & Co., Frankfurt am Main, Germany) reactive dyes. Typical chromophores are exemplified by those present in PROCION™ Red MX-8B, PROCION™ Yellow MX-3R, and PROCION™ Blue MX-2G shown in Scheme 4, below.

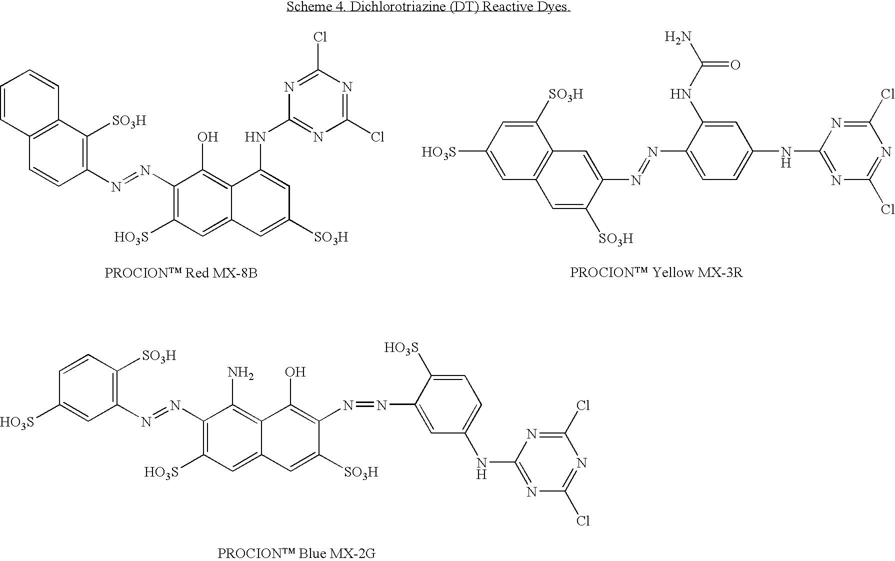

II.C. Linking Groups

In some embodiments, the halo-substituted, nitrogen-containing heterocycles of the presently disclosed reactive dyes can be attached to a chromophore or chromophores via one or more linker groups. The linker group can be any suitable bivalent group. A linker group can comprise a single heteroatom, such as NH, S, or O, or can include two heteroatoms and a linear, branched, cyclic, substituted or unsubstituted alkylene or arylene spacer group. For example, suitable linker groups include, but are not limited to, —O—, —S—, —(CH₂)ₖ— (i.e., an alkylene), arylene, —NR— (i.e., an amino linkage), —NR—(CH₂)ₖ—NR—, S—(CH₂)ₖ—NR—, —S—(CH₂)ₖ—S—, —O—(CH₂)ₖ—NR—, —O—(CH₂)ₖ—O—, —C(═O)NR— (i.e., an amide linkage), —C(═O)—(CH₂)ₖ—NR—, —NRSO₂—, and —SO₂—(CH₂)ₖ—, wherein R is H or C₁-C₈ alkyl and k is an integer with a value between 1 and 8. In some embodiments, R is a C₁-C₅ alkyl and k is an integer between 1 and 5 (i.e., 1, 2, 3, 4, or 5). Linker groups also include groups wherein the alkyl, alkylene, or arylene carbon atoms can be substituted by halogen, hydroxyl, cyano, C₁-C₄ alkoxy, C₂-C₅ alkoxycarbonyl, carboxyl, sulfamoyl, sulfo, or sulfato moieties.

Linker groups can also link a halo-substituted, nitrogen-containing heterocycles to the chromophore or chromophores via a multi-bonding moiety, which can be another one of the two or more halo-substituted nitrogen-containing heterocycles or another nitrogen-containing heterocycle. As used herein, the term “multi-bonding moiety” refers to a group that forms covalent bonds with at least three other moieties. Each nitrogen-containing heterocycle of the reactive dye compound (i.e., each halo-substituted, nitrogen-containing heterocycle, as well as any other nitrogen-containing heterocycles present) can be the same or different.

II.D. Reactive Dyes of Formula (I)

In some embodiments, the presently disclosed reactive dye can have a structure of Formula (I):

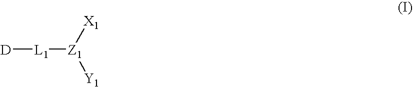

wherein:

D is a chromophore;

L₁ is selected from the group consisting of NR₁, NR₁C(═O), and NR₁(SO₂), wherein R₁ is H or alkyl;

Z₁ is a nitrogen-containing heterocycle;

X₁ has a structure of Formula (II):

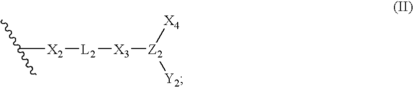

wherein:
X₂ is S, O, or NR₂, wherein R₂ is H or alkyl;
L₂ can be present or absent, and if present is selected from the group consisting of C₁-C₅ alkylene, C₁-C₅ substituted alkylene, and arylene;
X₃ can be present or absent, and if present is S, O, or NR₃, wherein R₃ is H or alkyl;
Z₂ is a nitrogen-containing heterocycle;
Y₂ is halo; and
X₄ is -L₃-Z₃-SO₂CH₂CH₂OSO₃H, wherein Z₃ is arylene and L₃ is NR₄, O, or S, wherein R₄ is H or alkyl; and

Y₁ is halo or a group having a structure of Formula (III):

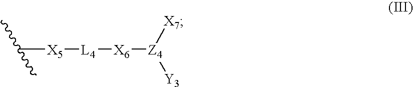

wherein:
X₅ is S, O, or NR₅, wherein R₅ is H or alkyl;
L₄ can be present or absent, and if present is selected from the group consisting of C₁-C₅ alkylene, C₁-C₅ substituted alkylene, and arylene;
X₆ can be present or absent, and if present is S, O, or NR₆, wherein R₆ is H or alkyl;
Z₄ is a nitrogen-containing heterocycle;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

Suitable nitrogen-containing heterocycles for use in the reactive dye compounds of Formula (I) can include any monocyclic, bicyclic, or polycyclic nitrogen-containing heterocycles as described hereinabove. In some embodiments, Z₁ and Z₂ are independently selected from the group consisting of triazine, pyrimidine, quinoxaline, phthalazine, pyridazone, and pyrazine.

The reactive dye compounds of Formula (I) can comprise at least one asymmetric bridging moiety (i.e., one asymmetric linker group present between two nitrogen-containing heterocycles). “Asymmetric” as used herein refers to a bridging moiety that comprises at least two different functional groups that react to form covalent bonds with another functional group. In some embodiments, the asymmetric bridging group is dissymmetric, which refers to a bridging moiety that comprises two different functional groups with different affinities (i.e., reactivities) for the reactive groups on the nitrogen-containing heterocycles. In some embodiments, X₁, Y₁, or both X₁ and Y₁ comprise an asymmetric bridging moiety. Thus, either Z₂ or Z₄ (or both) can be attached to Z₁ via an asymmetric bridging moiety.

In some embodiments, the bridging moiety is based on cysteamine or cysteine. For example, cysteamine can react with two different functional groups to form a bridging moiety having the structure:

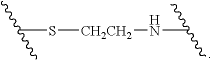

Cysteine can react with two different functional groups to form a bridging moiety having the structure:

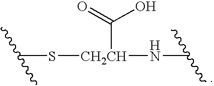

Asymmetric and/or dissymmetric bridging moieties can allow for better control of the synthesis of the reactive dye molecules. In particular, by choosing parameters such as reaction temperature and pH, it is possible to control the number and the way bridging moieties attach to other moieties such as multi-bonding nitrogen-containing heterocycles. The end (i.e., the sulfur or the nitrogen atom end in the case of cysteamine or cysteine) that bonds to a particular nitrogen-containing moiety can also be controlled.

Accordingly, in some embodiments, X₂ is S; L₂ is ethylene or carboxyl-substituted ethylene; and X₃ is NR₃, wherein R₃ is H. Thus, X₁ can have a structure of Formula (IIa):

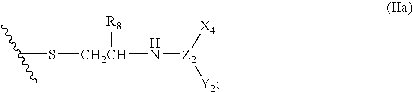

wherein R₈ is H or —COOH; Z₂ is selected from the group consisting of triazine, pyrimidine, quinoxaline, phthalazine, pyridazone, and pyrazine; Y₂ is halo; and X₄ is -L₃-Z₃-SO₂CH₂CH₂OSO₃H, wherein Z₃ is arylene and L₃ is NR₄, O, or S, wherein R₄ is H or alkyl. Alternatively, X₁ can have a structure of Formula (IIa′):

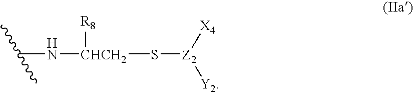

In some embodiments, at least one of the two or more halo-substituted, nitrogen-containing heterocycles can be a triazine, and the reactive dye can comprise one or more monohalotriazine group that is further substituted by a vinyl sulfone moiety (i.e., a monohalotriazine-vinyl sulfone). For example, in some embodiments, R₈ is H; Z₂ is triazine; Z₃ is phenylene; L₃ is NR₄, wherein R₄ is H; and X₁ has a structure of Formula (IIb):

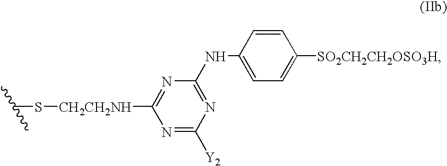

wherein Y₂ is chloro or fluoro.

In some embodiments, Y₂ is chloro and the monohalotriazine-vinyl sulfone group of Formula (IIb) is a monochlorotriazine-vinyl sulfone (MCT-VS) group having the structure:

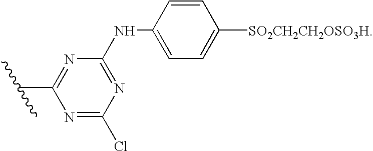

In some embodiments, Z₁ and Z₂ are each triazine; L₁ is NR₁, wherein R₁ is H; and the reactive dye compound has a structure of Formula (Ia):

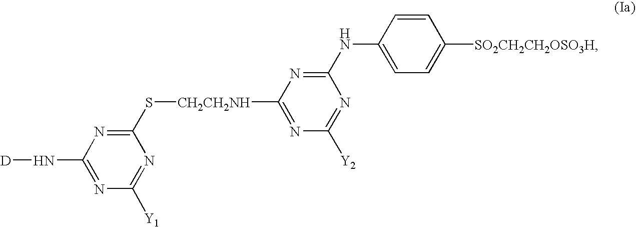

wherein D is a chromophore and Y₂ and Y₁ are independently chloro or fluoro.

In some embodiments, Y₁ and Y₂ are each Cl. Thus, the reactive dye compound of Formula (Ia) can have a structure comprising one (MCT-VS) group and one monochlorotriazine (MCT) group. In some embodiments, the reactive dye compound is selected from:

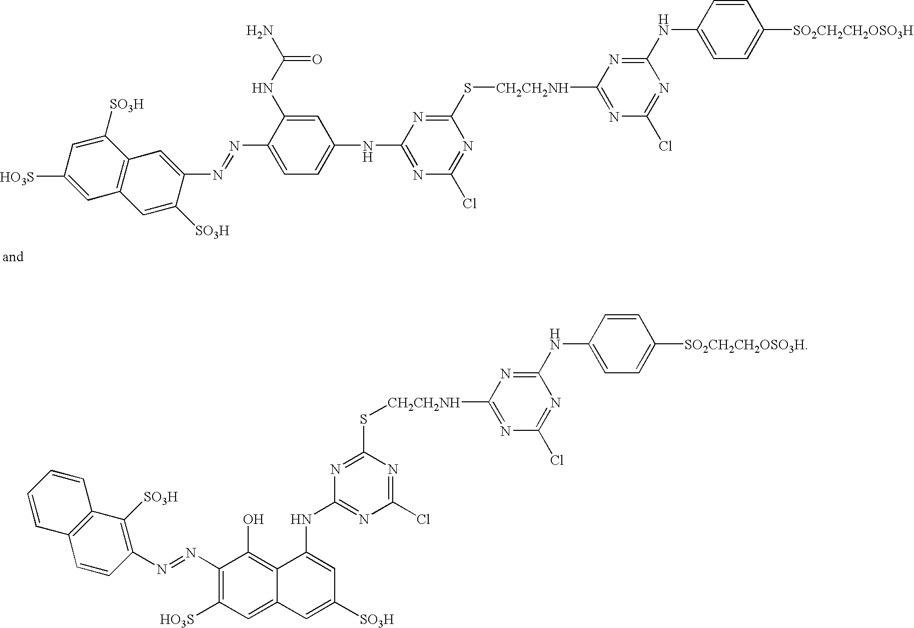

In some embodiments Y₁ has a structure of Formula (III) and comprises a halo-substituted, nitrogen-containing heterocycle, Z₄. For instance, in some embodiments, Y₁ has a structure of Formula (III) that includes a bridging moiety based on cysteamine or cysteine, wherein X₅ is S; L₄ is ethylene or carboxyl-substituted ethylene; and X₆ is NR₆, wherein R₆ is H. Thus, Y₁ can have a structure of Formula (IIIa):

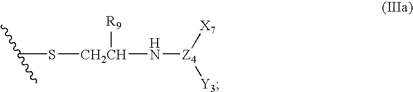

wherein R₉ is H or —COOH; Z₄ is selected from the group consisting of triazine, pyrimidine, quinoxaline, phthalazine, pyridazone, and pyrazine; Y₃ is halo; and X₇ is -L₅-Z₅-SO₂CH₂CH₂OSO₃H, wherein Z₅ is arylene and L₅ is NR₇, O, or S, wherein R₇ is H or alkyl. Alternatively, Y₁ can have a structure of Formula (IIIa′):

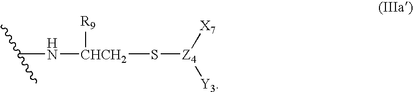

In some embodiments, the structure of Formula (III) comprises a monohalotriazine-vinyl sulfone group. For example, in some embodiments, R₉ is H; Z₄ is triazine; Z₅ is phenylene; L₅ is NR₇, wherein R₇ is H; and Y₁ is a structure of Formula (IIIb):

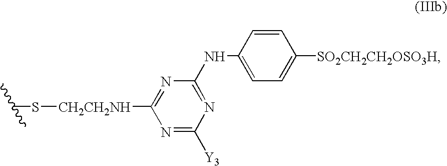

wherein Y₃ is chloro or fluoro.

In some embodiments, Z₁ is triazine; and L₁ is NR₁, wherein R₁ is H; and the reactive dye compound has a structure of Formula (Ib):

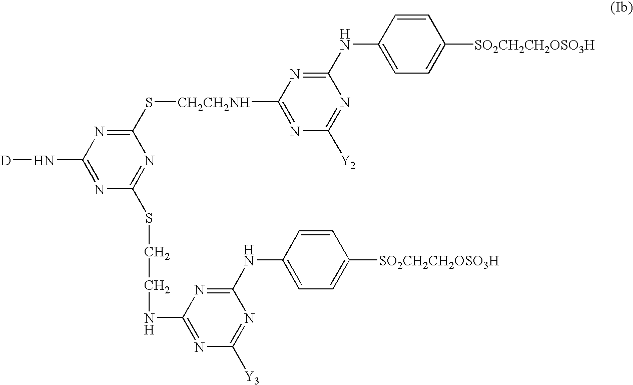

wherein D is a chromophore, and Y₂ and Y₃ are independently chloro or fluoro.

In some embodiments Y₂ and Y₃ are each Cl. Thus, in some embodiments, the reactive dye compound comprises two MCT-VS groups. Exemplary reactive dye compounds of the presently disclosed subject matter comprising two MCT-VS groups include:

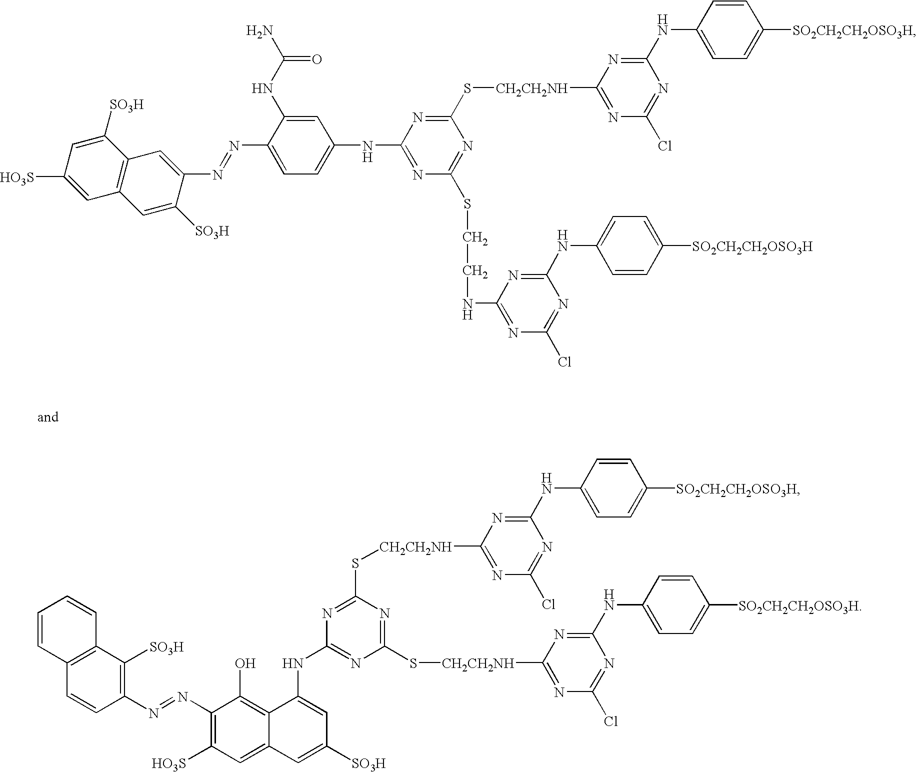

Accordingly, the heterobifunctional reactive dye compounds of the presently disclosed subject matter can comprise at least three or four moieties that can react with the substrate being dyed.

II.E. Synthesis of Reactive Dyes of Formula (I).

In some embodiments, the presently disclosed reactive dye compounds of Formula (I) can be prepared from a homobifunctional reactive dye (e.g. a DCT-based reactive dye). For example, the homobifunctional dye can be reacted with two equivalents of a linker precursor molecule (e.g., cysteamine or cysteine) to form an intermediate. The intermediate can then be reacted with two equivalents of a halo-substituted, nitrogen-containing heterocycle that is further substituted with a vinyl sulfone. This halo-substituted, vinyl sulfone-substituted, nitrogen-containing heterocycle can be prepared from the reaction of a halo-substituted, nitrogen-containing heterocycle (e.g., cyanuric chloride) and a nucleophilic, vinyl sulfone-containing molecule (e.g., para-aminobenzene-sulfatoethylsulfone). In some embodiments, the reactive dye compounds can be prepared from a homobifunctional reactive dye using one equivalent of linker precursor molecule, followed by one equivalent of halo-substituted, vinyl sulfone-substituted, nitrogen-containing heterocycle.

### III. Dye Compositions and Methods of Use

The reactive dye compounds disclosed herein are suitable for the coloration of a wide variety of substrates, such as silk, leather, wool, polyamide, polyester and polyurethanes, keratin fibers such as hair, and cellulosic materials. Cellulosic materials include, but are not limited to, cotton, linen, hemp, ramie, lyocell, and the like, paper, and also cellulose itself and regenerated cellulose. The substrates can also include blend fabrics comprising hydroxyl group containing fibers, for example, blends of cotton with polyester and/or polyamide fibers.

The reactive dye compounds can be formulated in various ways, e.g., in the form of a solid mixture; an aqueous solution, slurry or suspension; or in a printing paste. Thus, the presently disclosed subject matter relates to dye compositions comprising a reactive dye compound, wherein the reactive dye compound comprises two or more halo-substituted, nitrogen-containing heterocycles and an asymmetric bridging moiety, at least one of the halo-substituted, nitrogen-containing heterocycles further comprising a second reactive group (e.g., a vinyl sulfone). In some embodiments, the dye composition comprises one or more reactive dye compounds having a structure of Formula (I). In dye compositions to be applied to cellulosic fibers, the dye composition can comprise about 0.1% to about 10% reactive dye compound on weight of fiber (owf).

In some embodiments, the dye composition can also include one or more commercially available or previously known dye compounds, such as an oxidative dye, a direct dye, or a reactive dye, in addition to a reactive dye of the presently disclosed subject matter.

The dye composition can include any carrier material suitable for use in a dye composition. In some embodiments, the dye composition can comprise a carrier liquid, which can be any suitable solvent. For example, the carrier liquid can comprise water or distilled water. In some embodiments, such as when the dye composition is to be applied as a gel or paste, the dye composition can further comprise one or more thickening agents. Dye compositions can also include one or more stabilizer or crystallization inhibitor, such as polyvinylpyrrolidone (PVP) or a polyacrylic acid, to increase dye composition shelf life by decreasing dye precipitation or crystallization. Other additives and adjuvants that do not adversely affect the performance of the reactive dye composition can be used as desired. Such optional ingredients include, for example, wetting agents, deareators, defoamers, dye bath lubricants, and the like.

In some embodiments, the dye composition is a dye bath composition (i.e., a solution comprising one or more dye compounds and a liquid carrier, into which a substrate can be immersed for dyeing). The dye bath composition can comprise one or more salt, buffer, acidic, or basic compounds or components for controlling the pH and/or the ionic strength of the dye bath composition. Such additional compounds and components can be used to increase the solubility of the dye in the liquid carrier, to increase the affinity of the dye compound for the substrate, or to otherwise promote the reaction of the dye compound and the substrate.

In embodiments wherein a cellulosic substrate is to be dyed, the dye bath composition can comprise an alkali component in order to raise the pH of the dye bath composition to increase the concentration of oxyanions present on a hydroxyl-containing substrate, such as a cellulosic substrate. The pH of the dye bath composition can be raised to above about 8, to above about 9, or to between about 8 and about 10. In some embodiments, the pH can be raised to above 10, for example, to between about 10 and about 13 (10, 10.5, 11, 11.5, 12, 12.5, or 13). Suitable alkaline components include, but are not limited to, potassium hydroxide, sodium hydroxide, cesium hydroxide, sodium carbonate, sodium bicarbonate, potassium carbonate, potassium bicarbonate, and the like.

The additional pH-adjusting components can be added to the dye bath composition during a dyeing process or can be added within a time period (e.g., within a few seconds, minutes or hours) immediately prior to the use of the dye composition.

In some embodiments, the dye bath composition can comprise one or more salt compounds, such that the dye bath composition will have a salt concentration (i.e., a salt level) of less than 100 g/L. In some embodiments, the salt concentration of the dye bath composition will be about 70 g/L or less (e.g., about 70, 60, 50, 40, 30, 30, 20, 10, 5, or 1 g/L). In some embodiments, the salt concentration will be about 40 g/L or less. In some embodiments, the salt concentration will be about 20 g/L or less. In some embodiments, the salt is sodium chloride (NaCl).

The dyeing and printing processes that can be used with the dyes disclosed herein include conventional processes which one of skill in the art would recognize and which have been widely described in the technical and patent literature. The dye compounds and compositions disclosed herein are suitable for dyeing both by the exhaust method (long liquor) and also by the pad-dyeing method, whereby the material to be dyed is impregnated with aqueous, salt-containing or salt-free dye solutions. In the case of cellulosic substrates, the dye can be fixed after an alkali treatment or in the presence of alkali, if appropriate, with the application of heat. The dye compounds and compositions disclosed herein are also suitable for the cold pad-batch cellulosic fiber-dyeing method, after which the dye together with the alkali is applied to cellulosic fabric using a pad-mangle, batched on a roller and then fixed by storage at room temperature (for example, for a time period of between 4 and 24 hours). Alternatively, padded or printed substrates can be fixed by a steaming process using steam temperatures between 100-130° C. After fixing, the dyeings or prints can be thoroughly rinsed with cold and/or hot water. A surfactant can be added to the rinse to promote the removal of any unfixed dye molecules.

Accordingly, the presently disclosed subject matter provides a method of dyeing or printing a substrate, such as cotton and other cellulosic materials, wool, nylon, silk, keratin, leather, paper, and the like, using a reactive dye compound comprising two or more halo-substituted, nitrogen-containing heterocycles and an asymmetric bridging moiety, wherein at least one of the two or more halo-substituted, nitrogen-containing heterocycles further comprises a vinyl sulfone substituent. In some embodiments, the method comprises contacting a cellulosic substrate with a dye bath composition comprising a reactive dye compound, said reactive dye compound comprising two or more halo-substituted, nitrogen-containing heterocycles and an asymmetric bridging moiety, wherein at least one of the two or more halo-substituted, nitrogen-containing heterocycles further comprises a vinyl sulfone substituent. For example, the dyeing method can comprise applying an aqueous solution of one or more of the presently disclosed reactive dyes to the substrate under suitable conditions of pH and temperature.

In some embodiments, the cellulosic fiber is cotton or a cotton blend. In some embodiments, the dye bath composition comprises between about 0.1% and about 10% dye on weight of fiber. In some embodiments, the dye bath composition comprises 0.1% dye compound on weight of fiber. In some embodiments, the dye bath composition can comprise less than 0.1% of dye compound on weight of fiber.

In some embodiments, the dye bath composition comprises less than 100 g/L of salt. In some embodiments, the dye bath composition comprises 70 g/L of salt or less. In some embodiments, the dye bath composition comprises 40 g/L of salt or less. In some embodiments, the dye bath composition comprises 20 g/L of salt or less.

In some embodiments, the contacting of the cellulosic fiber with the dye bath composition is performed at an elevated temperature. For example, in some embodiments, the contacting is performed at a temperature of up to about 90° C. (i.e., between about room temperature 20° C. and about 90° C.). In some embodiments, the contacting is performed at a temperature of between about 30° C. and about 60° C. (e.g., about 30, 35, 40, 45, 50, 55, or 60° C.). After the reactive dye has been covalently bonded to the substrate, the substrate can be rinsed and dried in any suitable manner known in the art.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### General Methods and Materials

Commercial dyes were obtained from DyStar L.P. (Charlotte, N.C., United States of America). All other chemicals were from Aldrich Chemical Company, (Milwaukee, Wis., United States of America). Chemical reactions were followed using thin layer chromatography (TLC). The structures and purity of the dye products were confirmed by negative ion electrospray ionization mass spectroscopy (ESI-MS) and high performance liquid chromatography (HPLC).

### Example 1

### Synthesis of Dye Y1

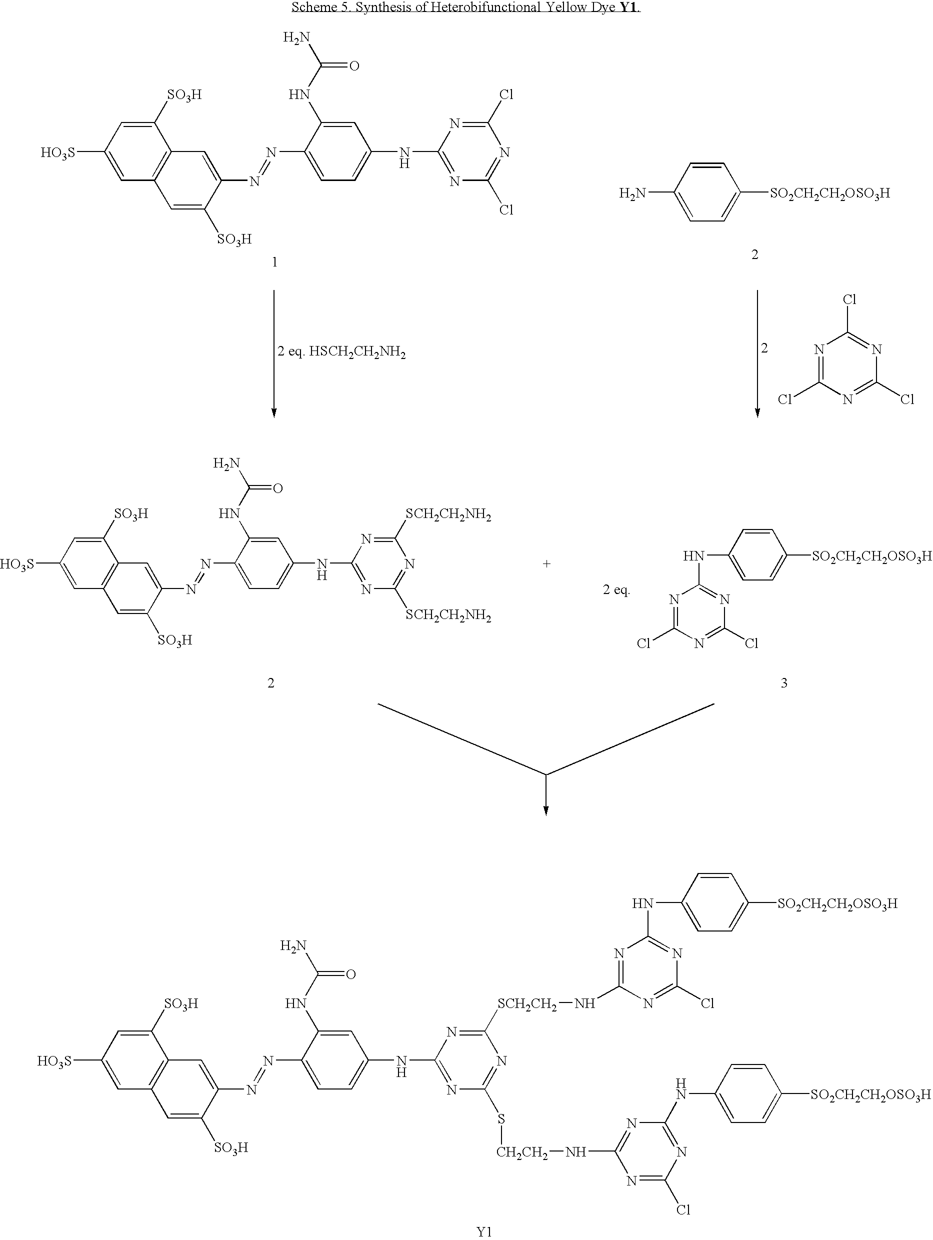

Heterobifunctional yellow dye Y1 was prepared as shown in Scheme 5, above. Commercially available DCT yellow dye CY (i.e., PROCION™ Yellow MX-3R, 4.9 g) was dissolved in water (20 mL) and stirred at room temperature. Cysteamine hydrochloride (2.0 eq.) was dissolved in water (20 mL) and added to the dye mixture dropwise. During the addition, the pH of the reaction mixture was maintained at between 7 and 7.5 by the addition of a 20% (w/v) aqueous solution of Na₂CO₃. Activated charcoal was added and the mixture was stirred for 10 min. The mixture was filtered and the filtrate diluted with 20% (w/v) aqueous KCl. The precipitated product was collected, washed with more aqueous KCl and with acetone, and dried to provide 3.9 g of compound 2.

4-β-Sulfatoethylsulfonylaniline (3.1 g) was dissolved in cold water (50 mL) and the pH was adjusted to between 6 and 7 using 20% (w/v) aqueous Na₂CO₃. The resulting solution was stirred with activated charcoal and filtered. A solution (30 mL) of cyanuric chloride (1.0 eq. based on the amount of 4-β-sulfatoethylsulfonylaniline) in acetone was added. The pH was maintained between 6 and 7 by the addition of Na₂CO₃ solution. After 1 hour, the reaction mixture was filtered and washed with acetone to provide intermediate compound 3.

Compound 2 was dissolved in water (20 mL) and stirred at 45-50° C. The pH was adjusted to between 7.0 and 7.5 by the addition of a 20% (w/v) aqueous solution of Na₂CO₃. Compound 3 (2.0 eq. based on the amount of compound 2) was added to the resultant solution and the mixture was stirred for 4 hours, maintaining the pH between 6.5 and 7.0. The product was then precipitated by adding 10% (w/v) aqueous KCl and by lowering the pH to about 5 using 20% (w/v) HCl. To complete precipitation, the resulting mixture was stirred for 2 hours. The mixture was filtered and the solid was washed with acetone and dried to provide 4.8 g of Y1.

The Y1 was added to N,N-dimethylformamide (DMF), stirred for 1 hour, and filtered. Ethyl acetate was added to the filtrate and the mixture stirred at room temperature for 1 hour. The precipitate was collected by filtration and dried to give 2.2 g (28.7%) of salt-free Y1.

### Example 2

### Synthesis of Dye Y2

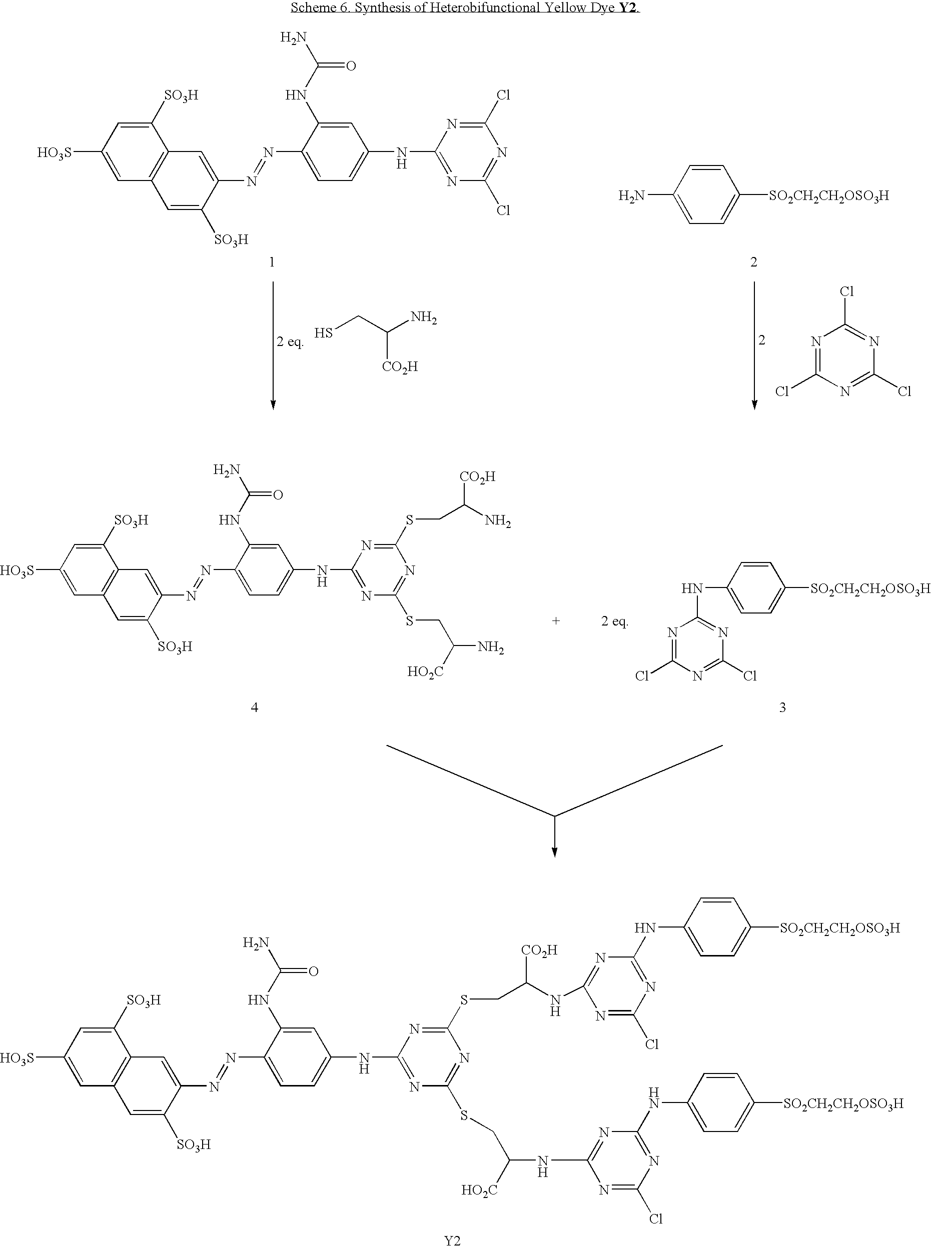

Heterobifunctional yellow dye Y2 was prepared as shown above in Scheme 6. The procedure was essentially as described above in Example 1 for Y1, with the exception that cysteine was used in place of cysteamine.

More particularly, CY (4.9 g) was dissolved in 15 mL water. L-Cysteine (2.0 eq.) was dissolved in 50 mL water and added to the solution of CY dropwise over two hours. The pH was maintained during the addition at between pH 7.0-7.5 by adding 20% (w/v) sodium carbonate. Activated charcoal was added and the mixture stirred for 10 min. The mixture was filtered, and the filtrate diluted in 50 mL of 20% (w/v) aqueous potassium chloride. The precipitate was collected, washed with additional aqueous KCl and with acetone, and dried to give 3.6 g of intermediate 4.

Di-cysteine-substituted intermediate 4 was dissolved in 15 mL water and stirred at 45-50° C., adjusting the pH to between 7.0-7.5 with 20% (w/v) aqueous sodium carbonate. To this solution was added 2.0 eq. of 3, obtained from condensing cyanuric chloride with an equimolar amount of 4-β-sulfatoethylsulfonylaniline, as a solid. The reaction was maintained at pH 6.5-7.0 with sodium carbonate solution. After 4 hours, Y2 was precipitated by adding 50 mL of 10% (w/v) aqueous potassium chloride and by lowering the pH to about 5 with 20% (w/v) HCl. After 2 hours, the mixture was filtered, and the solid was washed with acetone and dried to give 5.6 g Y2. The Y2 was added to in 80 mL DMF, stirred for 1 hour and filtered. Ethyl acetate (120 mL) was added to the filtrate and the mixture stirred for 1 hour and filtered to provide, after drying, 2.0 g (24%) salt-free Y2.

### Example 3

### Synthesis of Dye Y3

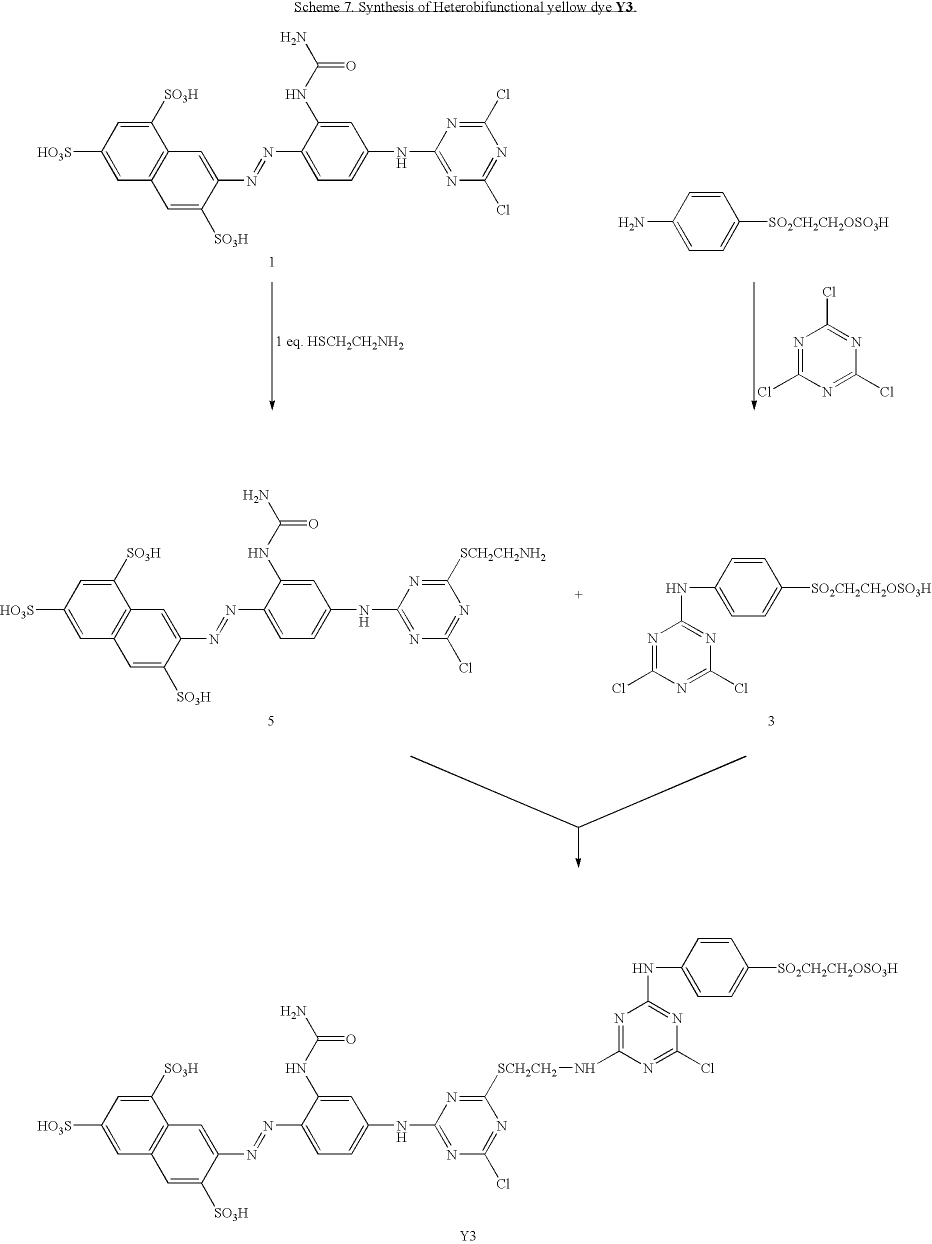

Heterobifunctional yellow dye Y3 was prepared as shown above in Scheme 7. The procedure was similar to that described in Example 1, except that only one equivalent of cysteamine and one equivalent of compound 3 were used.

CY (4.9 g) was dissolved in 20 mL of water and stirred at room temperature. Cysteamine hydrochloride (1.0 eq.) was dissolved in 10 mL of water and stirred at 0-10° C. as the CY solution was added dropwise over 2 hours. During addition, the pH was maintained between 7.0-7.5 by adding 20% (w/v) aqueous sodium carbonate. Activated charcoal was added and the mixture was stirred for 10 min. The mixture was filtered, and the filtrate diluted with 20% (w/v) aqueous KCl. The precipitated product was collected, washed with more aqueous KCl and with acetone, and dried to provide 3.2 g of intermediate 5. Intermediate 5 was dissolved in water (20 mL) and stirred at 45-50° C. The pH was adjusted to between 7.0 and 7.5 by the addition of 20% (w/v) aqueous Na₂CO₃. To this solution was added 1.0 eq. of 3, the product obtained from condensing cyanuric chloride with an equimolar amount of 4-β-sulfatoethylsulfonylaniline, as a solid. The resultant mixture was stirred for 4 hours, maintaining the pH between 6.5 and 7.0. The product was then precipitated by adding 10% (w/v) aqueous KCl and by lowering the pH to about 5 using 20% (w/v) HCl. To complete precipitation of the crude product, the resulting mixture was stirred for 2 hours. The mixture was filtered and the solid was washed with acetone and dried to provide 5.5 g of Y3. The Y3 was dissolved in 80 mL DMF, stirred for 1 hour, and filtered. Ethyl acetate (120 mL) was added to the filtrate and the mixture stirred at room temperature for 1 hour. The precipitate was collected by filtration and dried to give 2.1 g (36.5%) salt-free Y3.

### Example 4

### Synthesis of Dye R1

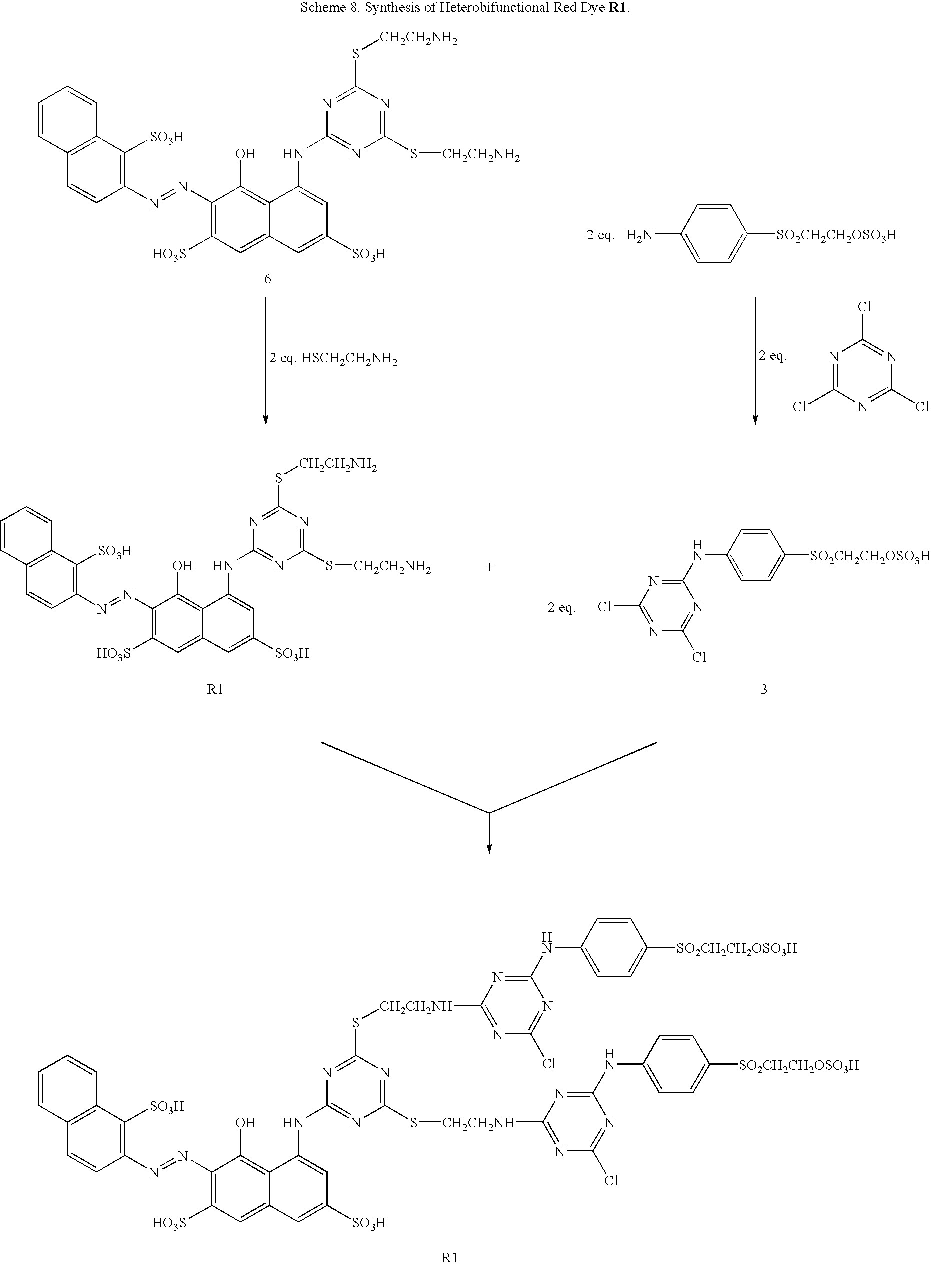

Heterobifunctional red dye R1 was prepared as shown above in Scheme 8, in a manner analogous to the synthesis of Y1, except starting from commercially available DCT red dye CR (i.e., PROCION™ Red MX-8B). Starting from 5.7 g (0.005 mol) of CR, 3.5 g of salt-free R1 was obtained.

### Example 5

### Synthesis of Dye R2

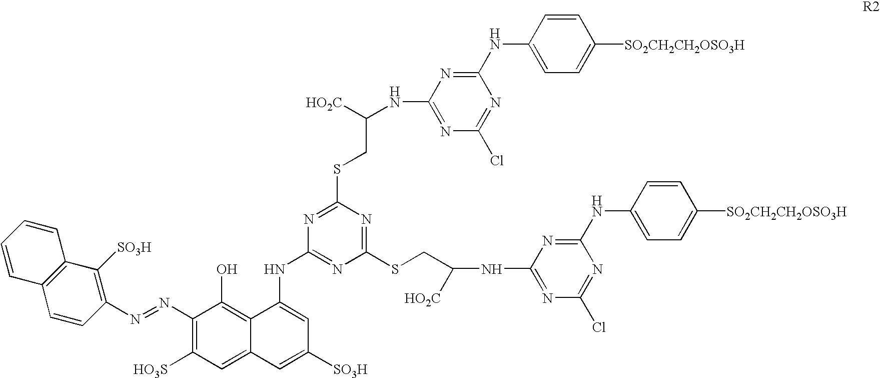 [0208] Scheme 9. Structure of Heterobifunctional Red Dye R2.

Heterobifunctional red dye R2 (3.4 g) was synthesized analogously to the synthesis described above for Y2 in Example 2, only starting from 5.7 g of CR.

### Example 6

### Synthesis of Dye R3

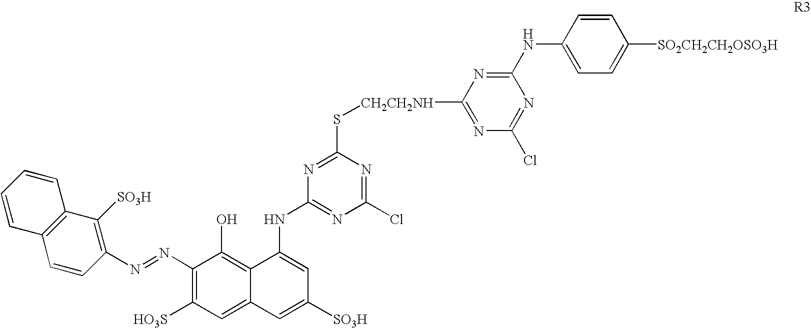 [0211] Scheme 10. Structure of Heterobifunctional Red Dye R3.

Heterobifunctional red dye R3 (3.6 g) was synthesized analogously to the synthesis described above for Y3 in Example 3, only starting from 5.7 g of CR.

### Example 7

### Visible Absorption Properties

The visible absorption spectra of CY, Y1, Y2, Y3, CR, R1, R2, and R3 were recorded. The absorption maximum (λₘₐₓ) and molecular absorptivity (εₘₐₓ) for each dye are shown below in Table 1. The εₘₐₓ values were calculated using the Beer-Lambert Law:

A=εbc

where A is the absorbance at λₘₐₓ, b is the path length of the sample container, and c is the concentration of reactive dye.

The data indicates that the new heterobifunctional reactive dyes have higher λₘₐₓ values than CY and CR. Incorporation of the linking group appears to cause a bathochromic shift.

TABLE 1
λₘₐₓ and εₘₐₓ Data for Commercial Dyes and Heterobifunctional
Reactive Dyes.

| Dye | λₘₐₓ (nm) | εₘₐₓ (L mol⁻¹cm⁻¹) |
|---|---|---|
| CY | 413 | 19,000 |
| Y1 | 431 | 24,000 |
| Y2 | 429 | 27,000 |
| Y3 | 423 | 24,000 |
| CR | 545 | 30,000 |
| R1 | 553 | 30,000 |
| R2 | 553 | 35,000 |
| R3 | 552 | 26,000 |

### Example 8

### Equilibrium Exhaustion Studies

Equilibrium dye exhaustion studies for the heterobifunctional reactive dyes Y1, Y2, Y3, R1, R2 and R3 were performed using a 1.0±0.1 g woven cotton square as the substrate in 40 mL dye baths comprising 1% dye (owf) and salt at four different salt levels (i.e., 0 g/L, 10 g/L, 40 g/L, and 70 g/L). Three dyeing temperatures (i.e., 30° C., 60° C., and 90° C.) and four dyeing times (24 hours, 48 hours, 72 hours, and 96 hours) were used. Following dyeing, the substrates were rinsed until no color came off and dried. The dye baths were saved for analysis. For comparison, exhaustion studies were also performed using CY and CR. The percent exhaustion (% E) and shade depth (K/S) values obtained from these studies were also compared to the values previously determined for cysteamine-containing bis-homobifunctional yellow and red reactive dyes. See Berger, R., Master Thesis, North Carolina State University, Color Chemistry Program, 2005. The structures of the bis-homobifunctional yellow and red dyes are shown below in Scheme 11.

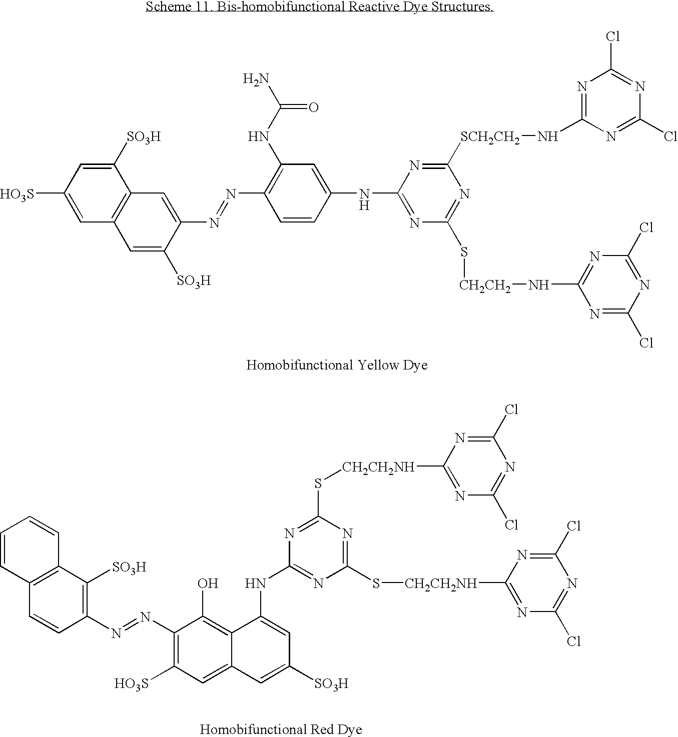

Results of the exhaustion studies indicated that heterobifunctional reactive dyes based on cysteamine have higher affinity (i.e., higher % E) for cotton than those based on cysteine. In particular, Y1 had the higher affinity than Y2, Y3, or CY. Y1 also had much higher affinity than the bis-homobifunctional yellow dye at dyeing temperatures of 60° C. and 90° C. at the 40 g/L and 70 g/L salt levels, and comparable affinity to that of the bis-homobifunctional yellow dye at 30° C. at the lower three salt levels. Y3 also showed good affinity compared with CY. Generally, the affinity of Y1 was not significantly affected by temperature, although the optimum temperature was 60° C. CY affinity decreased with increasing temperature.

Without being bound to any one theory, it is believed, that the high affinity of Y1 is due to its large molecular size, while the lower affinity of cysteine-based Y2 appears to be the result of its molecular geometry. According to molecular modeling studies, the presence of the carboxyl group on the cysteine-based linker of Y2 distorts the geometry of the dye, giving it a butterfly-like shape.

As with CY, CR affinity increases with salt concentration but decreases with temperature. R1 and R3 generally had higher affinity for cotton than CR. R1 also had higher affinity than the bis-homobifunctional red dye at 90° C. at all salt levels, and R3 had a higher affinity at 60° C. than the bis-homobifunctional red dye at 90° C. at any of the salt levels.

The best shade depth (K/S) values of the heterobifunctional reactive dyes were generally obtained using the mono-MCT-VS dyes Y3 and R3. In particular, Y3 had higher K/S values than CY at all dyeing conditions. Y3 also had higher K/S values at 60° C. and at 90° C. than the corresponding bis-homobifunctional reactive dye at 90° C., and Y1 had higher K/S values at 60° C. than the bis-homobifunctional reactive dye at 90° C. R3K/S values were highest at 60° C. and at 90° C.

### Example 9

### Dyeing Procedure

Plain weave 100% cotton fabric (10 g) was pre-wet and immersed in a dye bath having a 40:1 bath ratio comprising 0.1 g of dye (CY, Y1, Y3, CR, R1, or R3). The fabric was removed from the dye bath prior to each chemical addition and then re-immersed after each new chemical was mixed into the dye bath.

After 5 min, salt (NaCl) was added to the dye bath to provide a salt concentration of either 40 g/L or 70 g/L. The dye bath was heated to either 30° C. or 60° C. After 10 min, Na₂CO₃ was added to a concentration of 10 g/L. After a further 10 min, NaOH was added to the dye bath to a final concentration of 1 g/L. After 60 min, the dye bath was cooled to room temperature and the fabric was removed and rinsed under tap water for 2 min.

The rinsed fabric was placed in a steam heated kettle and washed for 20 min at 80° C. in 10 L water containing Apolloscour SDRS (2 g/L; Apollo Chemical Company, Burlington, N.C., United States of America). Excess Apolloscour was removed with a cold water rinse.

### Example 10

### Dye Performance

Visual inspection of the color depth of the initial dye baths indicated that the color of the Y3 and R3 dye baths was deeper than that of the Y1 and R1 dye baths. The initial Y1 and R1 dye baths in turn had deeper color than the initial dye baths comprising CY and CR. After dyeing, the color depth order of the dye baths for the yellow dyes was: CY>Y3>Y1. The color depth order for the dye baths for the red dyes after dyeing was: CR>R3>R1. For yellow dyes, the dye baths at 60° C. had deeper color than the dye baths at 30° C. For the red dyes, the dye baths at 30° C. had deeper color than those at 60° C.

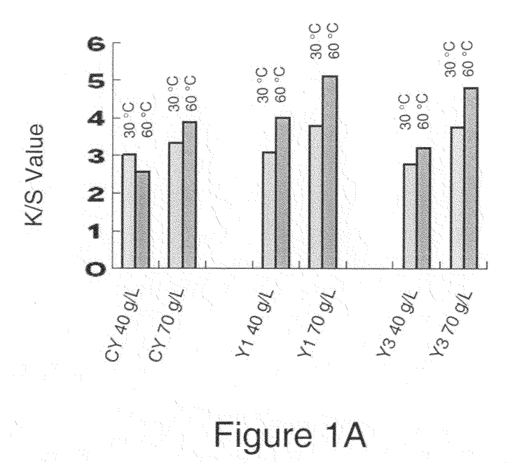

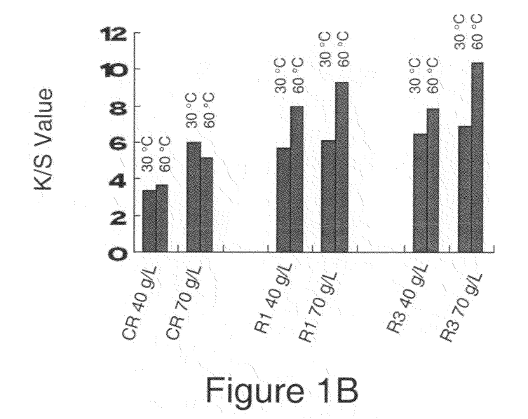

Colorometeric data of the dyed cotton samples was measured using a Datacolor International Spectroflash SFX instrument (Datacolor International, Lawrenceville, N.J., United States of America). FIG. 1A shows representative shade depth (K/S) data from cotton fabric dyed as described in Example 9 with heterobifunctional reactive dyes Y1 and Y3 under different dyeing conditions (i.e., at 30° C. and 60° C. and at 40 g/L and at 70 g/L salt). For comparison, the shade depth values of cotton fabric dyed with commercial yellow dye (CY) are also shown. FIG. 1B shows representative shade depth data from the cotton fabric dyed using heterobifunctional red dyes R1 and R3 and commercial red dye CR under different dyeing conditions. The K/S values and % fixation values are also listed in Table 2, below.

TABLE 2
K/S and % Fixation Data from Dyeing Studies.

| | Salt Level | Temperature | | |
|---|---|---|---|---|
| Dye | (g/L) | (° C.) | K/S | % Fixation |
| CY | 40 | 30 | 3.02 | 76.6 |
| | 70 | 30 | 3.34 | 84.5 |
| | 40 | 60 | 2.55 | 64.1 |
| | 70 | 60 | 3.88 | 74.6 |
| Y1 | 40 | 30 | 3.09 | 83.6 |
| | 70 | 30 | 3.80 | 90.2 |
| | 40 | 60 | 4.02 | 78.9 |
| | 70 | 60 | 5.12 | 87.5 |
| Y3 | 40 | 30 | 2.80 | 81.4 |
| | 70 | 30 | 3.76 | 88.7 |
| | 40 | 60 | 3.22 | 75.4 |
| | 70 | 60 | 4.81 | 86.1 |
| CR | 40 | 30 | 3.39 | 63.0 |
| | 70 | 30 | 5.98 | 74.5 |
| | 40 | 60 | 3.67 | 55.2 |
| | 70 | 60 | 5.13 | 68.1 |
| R1 | 40 | 30 | 5.73 | 73.2 |
| | 70 | 30 | 6.11 | 83.2 |
| | 40 | 60 | 7.96 | 81.0 |
| | 70 | 60 | 9.35 | 90.6 |
| R3 | 40 | 30 | 6.46 | 75.5 |
| | 70 | 30 | 6.91 | 82.2 |
| | 40 | 60 | 7.85 | 78.4 |
| | 70 | 60 | 10.36 | 87.2 |

In general, the heterobifunctional dyes gave comparable or deeper shades at the 40 g/L salt level than the corresponding commercial dye at a 70 g/L salt level. In comparison to their commercially available counterparts, the presently disclosed heterobifunctional reactive dye compounds comprising two MCT-VS groups provided 33-50% higher shade depths when dying cotton at a dyeing temperature of 60° C. with a dye bath comprising a salt concentration of 40 g/L.

Wash fastness and light fastness were determined using AATCC (American Association of Textile Chemists and Colorists) Test Methods 61-1999 (Test No. 2A) and 16-1998E, respectively. The wash fastness of cotton fabric samples dyed with CY, Y1, Y3, CR, R1, and R1 at either 40 g/L salt or 70 g/L salt and at either 30° C. or 60° C. is indicated by the color change ratings indicated below in Table 3. The light fastness of the same samples is indicated by the color change ratings in Table 4, below. The color change rating scale ranges from 1 (poor color fastness) to 5 (excellent color fastness).

TABLE 3
Wash Fastness of Commercial and Heterobifunctional Reactive Dyes.

| | Salt Level | Temperature | Color |
|---|---|---|---|
| Dye | (g/L) | (° C.) | Change |
| CY | 40 | 30 | 4 |
| | 70 | 30 | 4.5 |
| | 40 | 60 | 4 |
| | 70 | 60 | 3.5 |
| Y1 | 40 | 30 | 4.5 |
| | 70 | 30 | 4.5 |
| | 40 | 60 | 4.5 |
| | 70 | 60 | 4.5 |
| Y3 | 40 | 30 | 4 |
| | 70 | 30 | 4.5 |
| | 40 | 60 | 4.5 |
| | 70 | 60 | 4.5 |
| CR | 40 | 30 | 4.5 |
| | 70 | 30 | 4 |
| | 40 | 60 | 4.5 |
| | 70 | 60 | 4.5 |
| R1 | 40 | 30 | 4.5 |
| | 70 | 30 | 4.5 |
| | 40 | 60 | 4.5 |
| | 70 | 60 | 4.5 |
| R3 | 40 | 30 | 4.5 |
| | 70 | 30 | 4.5 |
| | 40 | 60 | 5.0 |
| | 70 | 60 | 4.5 |

TABLE 4
Light Fastness of Commercial and Heterobifunctional Reactive Dyes.

| | Salt Level | Temperature | Color |
|---|---|---|---|
| Dye | (g/L) | (° C.) | Change |
| CY | 40 | 30 | 4 |
| | 70 | 30 | 4.5 |
| | 40 | 60 | 4 |
| | 70 | 60 | 3.5 |
| Y1 | 40 | 30 | 4.5 |
| | 70 | 30 | 3.5 |
| | 40 | 60 | 3.5 |
| | 70 | 60 | 4 |
| Y3 | 40 | 30 | 4 |
| | 70 | 30 | 4 |
| | 40 | 60 | 4 |
| | 70 | 60 | 4 |
| CR | 40 | 30 | 3 |
| | 70 | 30 | 3.5 |
| | 40 | 60 | 3.5 |
| | 70 | 60 | 3.5 |
| R1 | 40 | 30 | 3.5 |
| | 70 | 30 | 3.5 |
| | 40 | 60 | 3 |
| | 70 | 60 | 3 |
| R3 | 40 | 30 | 3 |
| | 70 | 30 | 3 |
| | 40 | 60 | 3 |
| | 70 | 60 | 3 |

As indicated by the data shown in Tables 3 and 4, the stability of the heterobifunctional reactive dyes to washing and to UV light was comparable to that of their commercial counterparts CY and CR. Further, the heterobifunctional dyes appeared to provide better washfastness than their bis-homobifunctional counterparts and better lightfastness following dyeing at the 40 g/L salt level. See Berger, R., Master Thesis, North Carolina State University, Color Chemistry Program, 2005.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A reactive dye compound comprising two or more halo-substituted, nitrogen-containing heterocycles and an asymmetric bridging group, wherein at least one of the two or more halo-substituted, nitrogen-containing heterocycles comprises a vinyl sulfone substituent.

2. The reactive dye compound of claim 1, wherein two of the two or more halo-substituted, nitrogen-containing heterocycles comprise a vinyl sulfone substituent.

3. The reactive dye compound of claim 1, wherein the asymmetric bridging group is based on the structure of cysteine or cysteamine.

4. The reactive dye compound of claim 1, wherein the reactive dye compound has a structure of Formula (I): 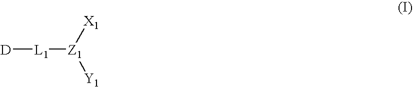
wherein:
D is a chromophore;
L₁ is selected from the group consisting of NR₁, NR₁C(═O), and NR₁(SO₂), wherein R₁ is H or alkyl;
Z₁ is a nitrogen-containing heterocycle;
X₁ has a structure of Formula (II): 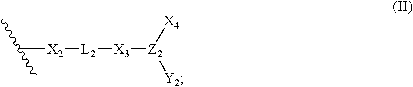
wherein:
X₂ is S, O, or NR₂, wherein R₂ is H or alkyl;
L₂ can be present or absent, and if present is selected from the group consisting of C₁-C₅ alkylene; C₁-C₅ substituted alkylene, and arylene;
X₃ can be present or absent, and if present is S, O, or NR₃, wherein R₃ is H or alkyl;
Z₂ is a nitrogen-containing heterocycle;
Y₂ is halo; and
X₄ is -L₃-Z₃-SO₂CH₂CH₂OSO₃H, wherein Z₃ is arylene and L₃ is NR₄, O, or S, wherein R₄ is H or alkyl; and
Y₁ is halo or a group having a structure of Formula (III): 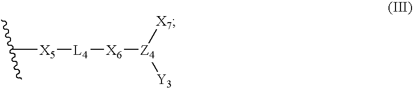
wherein:
X₅ is S, O, or NR₅, wherein R₅ is H or alkyl;
L₄ can be present or absent, and if present is selected from the group consisting of C₁-C₅ alkylene, C₁-C₅ substituted alkylene, and arylene;
X₆ can be present or absent, and if present is S, O, or NR₆, wherein R₆ is H or alkyl;
Z₄ is a nitrogen-containing heterocycle;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

5. The reactive dye compound of claim 4, wherein Z₁ and Z₂ are independently selected from the group consisting of triazine, pyrimidine, quinoxaline, phthalazine, pyridazone, and pyrazine.

6. The reactive dye compound of claim 5, wherein X₂ is S; L₂ is ethylene or carboxyl-substituted ethylene; and X₃ is NR₃, wherein R₃ is H; and X₁ has a structure of Formula (IIa): 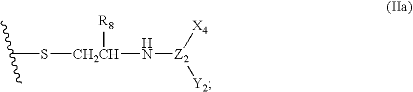
wherein:
R₈ is H or —COOH;
Z₂ is selected from the group consisting of triazine, pyrimidine, quinoxaline, phthalazine, pyridazone, and pyrazine;
Y₂ is halo; and
X₄ is -L₃-Z₃-SO₂CH₂CH₂OSO₃H, wherein Z₃ is arylene and L₃ is NR₄, O, or S, wherein R₄ is H or alkyl.

7. The reactive dye compound of claim 6, wherein R₈ is H; Z₂ is triazine; Z₃ is phenylene; L₃ is NR₄, wherein R₄ is H; and X₁ has a structure of Formula (IIb): 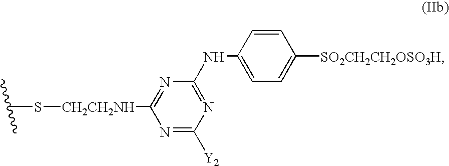
wherein Y₂ is chloro or fluoro.

8. The reactive dye compound of claim 7, wherein Z₁ is triazine; L, is NR₁, wherein R₁ is H; and the reactive dye compound has a structure of Formula (Ia): 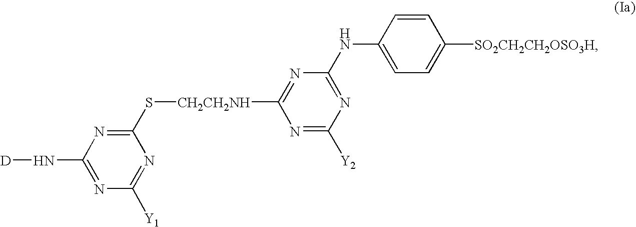
wherein:
D is a chromophore;
Y₂ is chloro or fluoro; and
Y₁ is chloro or fluoro.

9. The reactive dye compound of claim 8, wherein Y₁ and Y₂ are each Cl.

10. The reactive dye compound of claim 9, wherein the reactive dye compound is selected from:

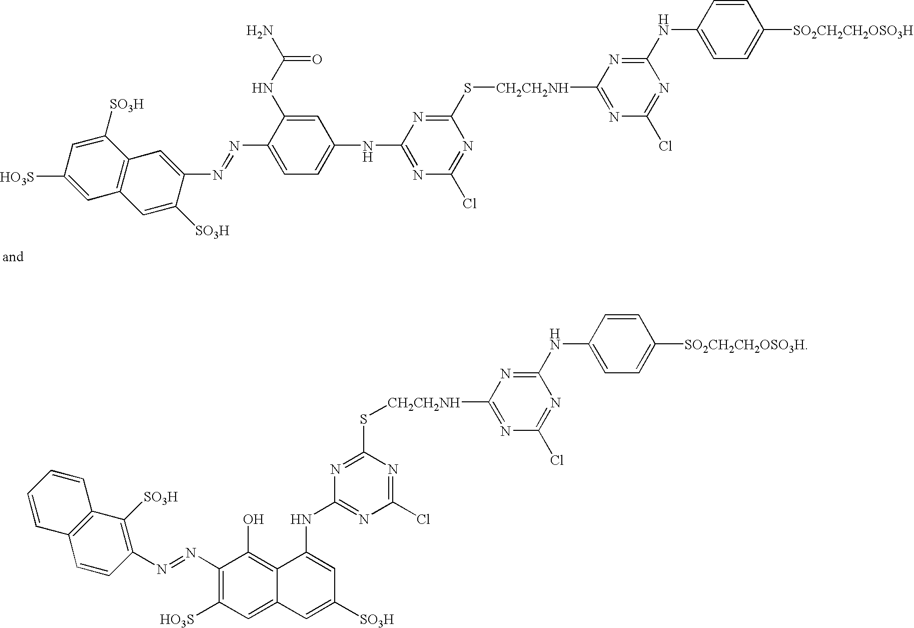

11. The reactive dye compound of claim 7, wherein X₅ is S; L₄ is ethylene or carboxyl-substituted ethylene; X₆ is NR₆, wherein R₆ is H; and Y₁ has a structure of Formula (IIIa): 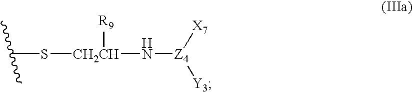
wherein:
R₉ is H or —COOH;
Z₄ is selected from the group consisting of triazine, pyrimidine, quinoxaline, phthalazine, pyridazone, and pyrazine;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

12. The compound of claim 11, wherein R₉ is H; Z₄ is triazine; Z₅ is phenylene; L₅ is NR₇, wherein R₇ is H; and Y₁ is a structure of Formula (IIIb): 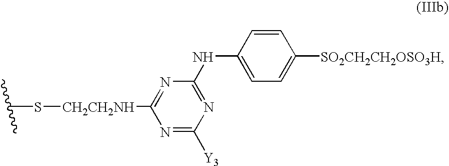
wherein Y₃ is chloro or fluoro.

13. The compound of claim 12, wherein Z₁ is triazine; and L₁ is NR₁, wherein R₁ is H; and the reactive dye compound has a structure of Formula (Ib): 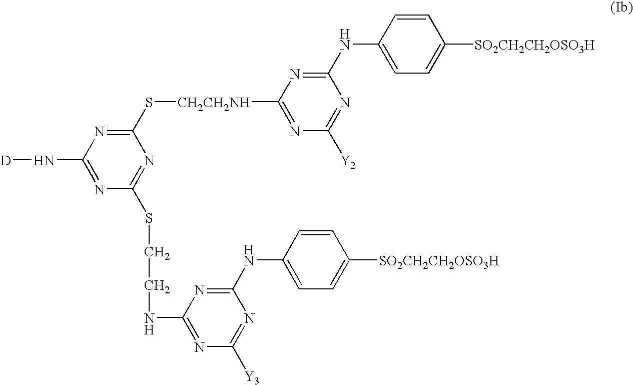
wherein:
D is a chromophore; and
Y₂ and Y₃ are independently chloro or fluoro.

14. The reactive dye compound of claim 13, wherein Y₂ and Y₃ are each Cl.

15. The reactive dye compound of claim 14, wherein the reactive dye compound is selected from the group consisting of:

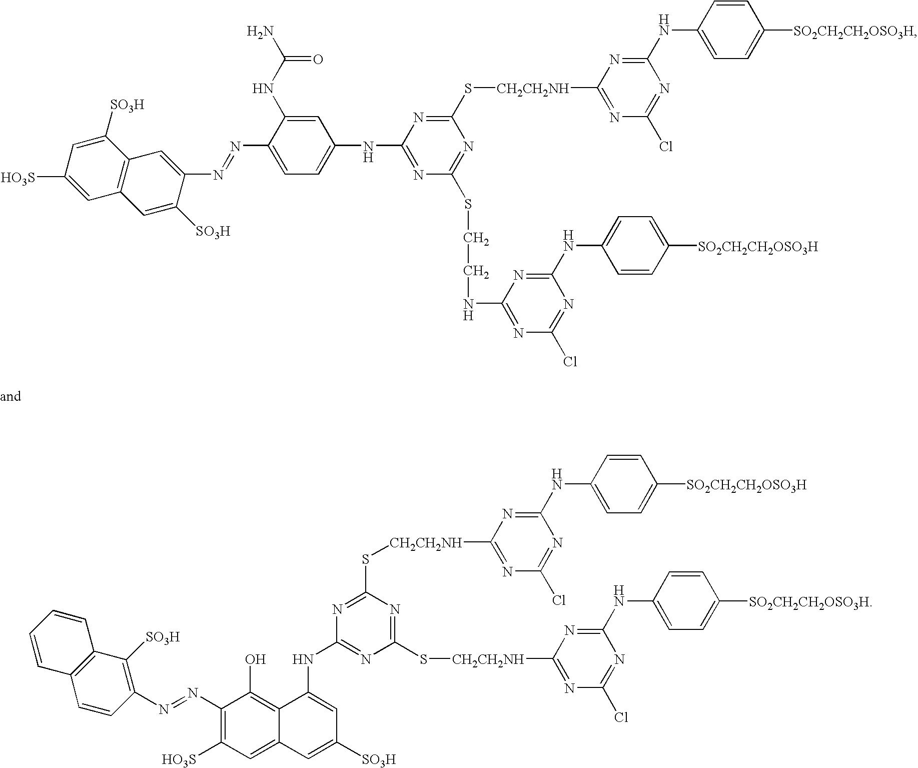

16. A dye bath composition comprising a reactive dye compound, said reactive dye compound comprising two or more halo-substituted, nitrogen-containing heterocycles and an asymmetric bridging group, wherein at least one of the two or more halo-substituted, nitrogen-containing heterocycles comprises a vinyl sulfone substituent.

17. The dye bath composition of claim 16, wherein the asymmetric bridging group is based on the structure of cysteine or cysteamine.

18. A dye bath composition of claim 16, wherein the reactive dye compound has a structure of Formula (I): 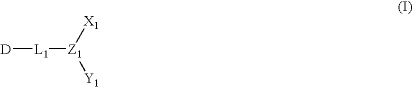
wherein:
D is a chromophore;
L₁ is selected from the group consisting of NR₁, NR₁C(═O), and NR₁(SO₂), wherein R₁ is H or alkyl;
Z₁ is a nitrogen-containing heterocycle;
X₁ has a structure of Formula (II): 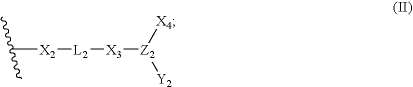
wherein:
X₂ is S, O, or NR₂; wherein R₂ is H or alkyl;
L₂ can be present or absent, and if present is selected from the group consisting of C₁-C₅ alkylene, C₁-C₅ substituted alkylene, and arylene;
X₃ can be present or absent, and if present is S, O, or NR₃; wherein R₃ is H or alkyl;
Z₂ is a nitrogen containing heterocycle;
Y₂ is halo; and
X₄ is -L₃-Z₃-SO₂CH₂CH₂OSO₃H, wherein Z₃ is arylene and L₃ is NR₄, O, or S, wherein R₄ is H or alkyl; and
Y₁ is halo or a group having a structure of Formula (III): 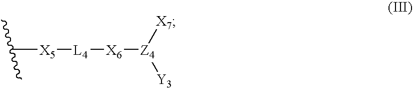
wherein:
X₅ is S, O, or NR₅; wherein R₅ is H or alkyl;
L₄ can be present or absent, and if present is selected from the group consisting of C₁-C₅ alkylene, C₁-C₅ substituted alkylene, and arylene;
X₆ can be present or absent, and if present is S, O, or NR₆; wherein R₆ is H or alkyl;
Z₄ is a nitrogen containing heterocycle;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

19. The dye bath composition of claim 16, further comprising a salt, wherein the dye bath composition has a salt concentration of about 70 g/L or less.

20. The dye bath composition of claim 19, wherein the salt concentration is about 40 g/L or less.

21. The dye bath composition of claim 20, wherein the salt concentration is about 20 g/L or less.

22. The dye bath composition of claim 19, wherein the salt is sodium chloride.

23. A method of dyeing a cellulosic fiber comprising contacting the cellulosic fiber with a dye bath composition comprising a reactive dye compound, said reactive dye compound comprising two or more halo-substituted, nitrogen-containing heterocycles and an asymmetric bridging group, wherein at least one of the two or more halo-substituted, nitrogen-containing heterocycles comprises a vinyl sulfone substituent.

24. The method of claim 23, wherein the asymmetric bridging group is based on the structure of cysteine or cysteamine.

25. The method of claim 23, wherein the reactive dye compound has a structure of Formula (I): 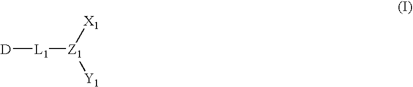
wherein:
D is a chromophore;
L₁ is selected from the group consisting of NR₁, NR₁C(═O), and NR₁(SO₂), wherein R₁ is H or alkyl;
Z₁ is a nitrogen-containing heterocycle;
X₁ has a structure of Formula (II): 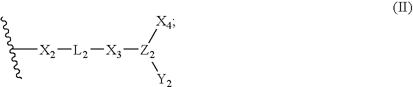
wherein:
X₂ is S, O, or NR₂; wherein R₂ is H or alkyl;
L₂ can be present or absent, and if present is selected from the group consisting of C₁-C₅ alkylene, C₁-C₅ substituted alkylene, and arylene;
X₃ can be present or absent, and if present is S, O, or NR₃; wherein R₃ is H or alkyl;
Z₂ is a nitrogen containing heterocycle;
Y₂ is halo; and
X₄ is -L₃-Z₃-SO₂CH₂CH₂OSO₃H, wherein Z₃ is arylene and L₃ is NR₄, O, or S, wherein R₄ is H or alkyl; and
Y₁ is halo or a group having a structure of Formula (III): 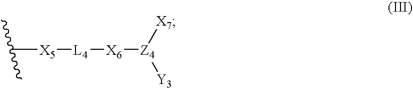
wherein:
X₅ is S, O, or NR₅; wherein R₅ is H or alkyl;
L₄ can be present or absent, and if present is selected from the group consisting of C₁-C₅ alkylene, C₁-C₅ substituted alkylene, and arylene;
X₆ can be present or absent, and if present is S, O, or NR₆; wherein R₆ is H or alkyl;
Z₄ is a nitrogen containing heterocycle;
Y₃ is halo; and
X₇ is -L₅-Z₅-SO₂CH₂CH₂OSO₃H, wherein Z₅ is arylene and L₅ is NR₇, O, or S, wherein R₇ is H or alkyl.

26. The method of claim 23, wherein the cellulosic fiber is cotton.

27. The method of claim 23, wherein the dye bath composition comprises 70 g/L of salt or less.

28. The method of claim 27, wherein the dye bath composition comprises 40 g/L of salt or less.

29. The method of claim 23, wherein contacting the cellulosic fiber with the dye bath composition is performed at a temperature of up to about 90° C.

30. The method of claim 29, wherein the temperature is between about 30° C. and about 60° C.
